(19) United States
(12) Patent Application Publication
(10) Pub. No.: US 2008/0189133 A1
(43) Pub. Date: Aug. 7, 2008

(54) Health care education systems

(75) Inventors: David E. Wilson, Bloomfield Hills, MI (US); Joseph K. Hart, Rochester, MI (US)

Correspondence Address: HARNESS, DICKEY & PIERCE, P.L.C., P.O. BOX 828, BLOOMFIELD HILLS, MI, 48303, US

(73) Assignee: Asset Health, Inc., Troy, MI (US)

(21) Appl. No.: 11/716,718

(22) Filed: Mar. 9, 2007

Related U.S. Application Data
(60) Provisional application No. 60/898,839, filed on Feb. 1, 2007.

(51) Int. Cl. G06Q 50/00

(52) U.S. Cl. 705/2

(57) ABSTRACT

A computer program product for managing health care educational information is provided. The computer program product includes a course assignment module that is operable to assign health care educational courses to a plurality of health care recipients. A reward management module is operable to associate rewards with the heath care educational courses. A course administration module is operable to administer the health care educational courses to the plurality of health care recipients and to award rewards based on a performance of the health care educational courses.

### CROSS-REFERENCE TO RELATED APPLICATIONS

This application claims the benefit of U.S. Provisional Application No. 60/898,839, filed on Feb. 1, 2007. The disclosure of the above application is incorporated herein by reference.

### FIELD

The present disclosure relates to computer systems for managing health care education programs.

### BACKGROUND

The statements in this section merely provide background information related to the present disclosure and may not constitute prior art.

The World Wide Web currently hosts a plethora of resources that contain health care information such as wellness and disease information, benefits information, and health care management philosophy information. The health care information, if read, would be helpful to an individual managing their health care. Such resources are only beneficial to those who actively seek the information. In some instances, individuals may be frustrated by the fact that they do not necessarily know where to look for particular information, they do not know what information to look for, or they do not know what sites contain reliable information. In addition, the information may not be arranged in a way that is particularly useful, relevant, or easy to understand. In other instances, individuals may merely lack the motivation to seek out the information.

Often times, employers wish to disseminate health care educational information to their employees in hopes to help improve their employee's physical health. If an overwhelming amount of educational information is passed on to the employee, the employee more than likely will ignore the information. Likewise, if a large amount of the information is not applicable to a physical trait of the employee, the employee is more than likely to ignore the information.

Thus, the need exists for a system that automatically disseminates applicable and reliable health care educational information to individuals. In addition, a system is needed that provides incentives to the individuals for participating in the educational information.

### SUMMARY

Accordingly, a computer program product for managing health care educational information is provided. The computer program product includes a course assignment module that is operable to assign health care educational courses to a plurality of health care recipients. A reward management module is operable to associate rewards with the heath care educational courses. A course administration module is operable to administer the health care educational courses to the plurality of health care recipients and to award the rewards based on a performance of the health care educational courses.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a functional block diagram illustrating a health care education management system in accordance with various aspects of the present teachings.

FIG. 2 is a dataflow diagram illustrating a health care education management software system in accordance with various aspects of the present teachings.

FIG. 3 is a block diagram illustrating layers of a health care education management module as shown in FIG. 2 in accordance with various aspects of the present teachings.

FIG. 4 is a dataflow diagram illustrating a course builder sub-module of the health care education management module shown in FIG. 2 in accordance with various aspects of the present teachings.

FIGS. 5A-50 illustrate exemplary course builder user interfaces that can be generated by an interface management module as shown in FIG. 2 in accordance with various aspects of the present teachings.

FIG. 6 is a dataflow diagram illustrating a client management sub-module of the health care education management module shown in FIG. 2 in accordance with various aspects of the present teachings.

FIGS. 7A-7F illustrate exemplary client management user interfaces that can be generated by the interface management module as shown in FIG. 2 in accordance with various aspects of the present teachings.

FIG. 8 is a dataflow diagram illustrating a recipient data import sub-module of the health care education management module shown in FIG. 2 in accordance with various aspects of the present teachings.

FIGS. 9A-9H illustrate exemplary recipient configuration user interfaces that can be generated by the interface management module as shown in FIG. 2 in accordance with various aspects of the present teachings.

FIG. 10 is a dataflow diagram illustrating a course assignment sub-module of the health care education management module shown in FIG. 2 in accordance with various aspects of the present teachings.

FIGS. 11A and 11B illustrate exemplary course assignment user interfaces that can be generated by the interface management module as shown in FIG. 2 in accordance with various aspects of the present teachings.

FIG. 12 is a dataflow diagram illustrating a reward management sub-module of the health care education management module shown in FIG. 2 in accordance with various aspects of the present teachings.

FIGS. 13A and 13B illustrate exemplary reward management user interfaces that can be generated by the interface management module as shown in FIG. 2 in accordance with various aspects of the present teachings.

FIG. 14 is a dataflow diagram illustrating a course administration sub-module of the health care education management module shown in FIG. 2 in accordance with various aspects of the present teachings.

FIGS. 15A-15C illustrate exemplary course administration user interfaces that can be generated by the interface management module as shown in FIG. 2 in accordance with various aspects of the present teachings.

FIG. 16 is a dataflow diagram illustrating a data export sub-module of the health care education management module shown in FIG. 2 in accordance with various aspects of the present teachings.

FIGS. 17A-17G illustrate exemplary data export user interfaces that can be generated by the interface management module as shown in FIG. 2 in accordance with various aspects of the present teachings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

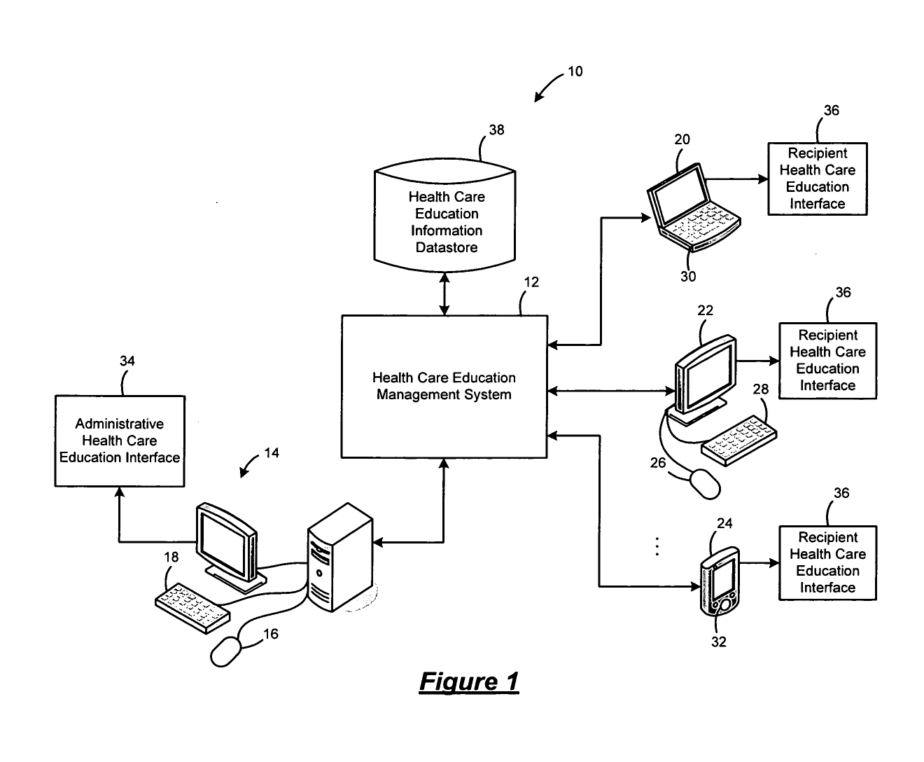

Referring to FIG. 1, a computer system including a health care education management system 12 is shown generally at 10. The computer system 10 includes a computer 14 that is shown to be associated with one or more input devices 16 and 18 used by a system administrator or a client to communicate with the computer 14. As can be appreciated, such input devices 16 and 18 may include, but are not limited to, a mouse, a keyboard, a joystick, a microphone, and a touchpad. The computer 14 includes a processor (not shown) and one or more data storage devices (not shown). The one or more data storage devices can be at least one of random access memory (RAM), read only memory (ROM), a cache, a stack, or the like which may temporarily or permanently store electronic data of the computer 14. The processor of the computer 14 is operable to execute one or more set of instructions contained in software. The health care education management system 12 includes software instructions in accordance with the present disclosure. The health care education management system 12 can be installed to the computer 14 or run by the processor of the computer 14 from a portable storage device, such as a CD-ROM (not shown). In various other embodiments, the health care education management system 12 can be downloaded via the internet (not shown) or run from a remote location, such as from a remote server (not shown).

The health care education management system 12 communicates with a plurality of electronic devices 20, 22, and 24 that are used by health care recipients or clients. The health care recipients are employed by or associated with a client. Such electronic devices 20, 22, and 24 can include, but are not limited to, a laptop, a work station, a personal digital assistant (PDA), a desk top computer, and a cell phone. Each electronic device 20, 22, and 24 is shown to be associated with one or more input devices 26, 28, 30, and 32 used by the health care recipients or clients to communicate with the electronic device 20, 22, and 24. As can be appreciated, such input devices 26, 28, 30, and 32 may include, but are not limited to, a mouse, a keyboard, a joystick, a microphone, and a touchpad. Insofar as the present disclosure is concerned, communications between the health care education management system 12, the computer 14, and/or the electronic devices 20, 22, and 24 can be according to any known communication protocol including, but not limited to, USB, Wi-Fi, Bluetooth, TCP, and IEEE.

As will be discussed in more detail below, the health care education management system 12 is operable to develop and manage health care education courses and/or tests for health care recipients that are associated with or employed by one or more clients. The system administrator or the clients communicate with the health care education management system 12 via an administrative health care education user interface 34. The health care recipients or clients communicate with the health care education management system 12 via a recipient health care education user interface 36. A health care education information (HEI) datastore 38 stores information relating to the health care courses and/or tests, the clients, and the health care recipients for use by the health care education management system 12.

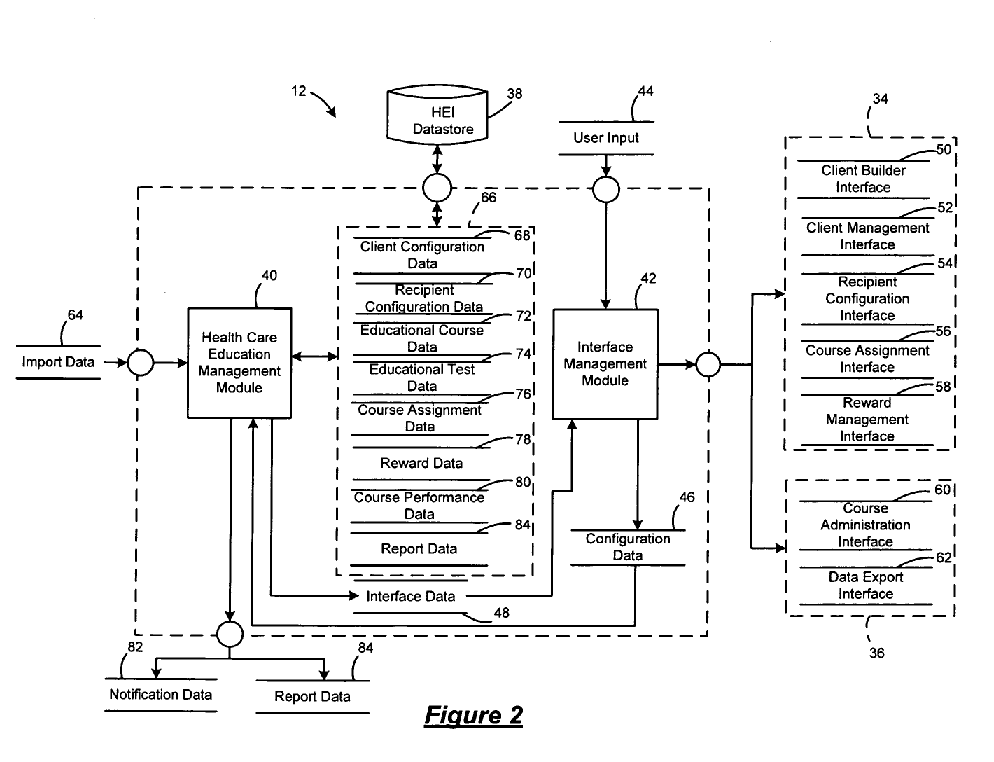

Referring now to FIG. 2, an exemplary embodiment of the health care education management system 12 includes one or more software modules. As can be appreciated, the software modules shown in FIG. 2 may be combined and/or further partitioned to similarly develop and manage health care educational courses and/or tests on behalf of one or more clients. Inputs to the health care education management system 12 can be received from user input devices 16, 18, 26, 28, 30, and 32 (FIG. 1), imported from data files, and/or retrieved from the HEI datastore 38.

According to a high level embodiment, as shown in FIG. 2, the health care education management system 12 includes a health care education management module 40 and an interface management module 42. The interface management module 42 receives as input user input 44 generated from the input devices 16, 18, 26, 28, 30, and 32 (FIG. 1) and converts the user input 44 to configuration data 46 for processing by the health care education management module 40. The interface management module 42 generates the administrative health care education user interface 34 and the recipient health care education user interface 36 to be displayed by the computer 14 (FIG. 1) and the electronic devices 20, 22, and 24 (FIG. 1) respectively.

The user interfaces 34 and 36 are generated based on interface data 48 received from the health care education management module 40. In various embodiments, the interface management module translates the interface data 48 into a web programming language such as, but not limited to, HTML, XML, PHP, ASP, and Perl. The translated interface data along with predefined interface data makes up the various interfaces. As will be discussed in more detail below, the administrative health care education user interface 34 can include one or more course builder interfaces 50, client management interfaces 52, recipient configuration interfaces 54, course assignment interfaces 56, and reward management interfaces 58. The recipient health care education user interface 36 can include one or more course administration interfaces 60 and data export interfaces 62.

The health care education management module 40 receives as input the configuration data 46 generated by the interface management module 42 and import data 64 extracted from various import files. Based on the configuration data 46, the health care education management module 40 manages health care education data 66 for one or more clients. The health care education data 66 can be stored to and retrieved from the HEI datastore 38. The health care education data 66 can include client configuration data 68, recipient configuration data 70, educational course data 72, educational test data 74, course assignment data 76, reward data 78, course performance data 80, and report data 84. In addition, the health care education management module 40 can generate notification data 82 and report data 84 for the system administrator, the clients, or the health care recipients. As discussed above, the health care education management module 40 generates interface data 48 used by the interface management module 42 to generate the various user interfaces 34 and 36.

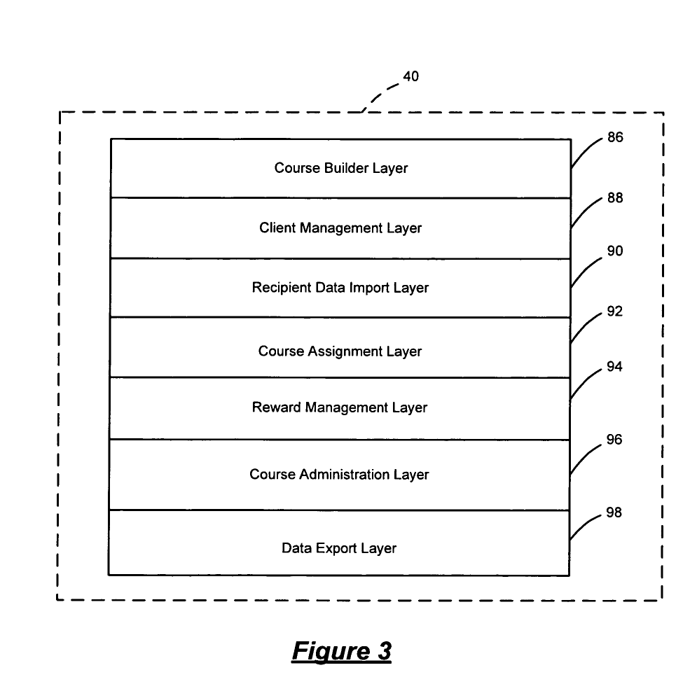

As shown in FIG. 3, the functionality of the health care education management module 40 can be split up into various conceptual layers. In an exemplary embodiment, the health care education management module 40 can include a course builder layer 86, a client management layer 88, a recipient data import layer 90, a course assignment layer 92, a reward management layer 94, a course administration layer 96, and a data export layer 98. Each layer can communicate data to and receive data from the HEI datastore 38, as well as to and from the other layers.

Generally speaking, the course builder layer 86 creates and manages electronic educational courses and/or electronic educational tests for the health care education program. The client management layer 88 configures new clients and their respective client information. The recipient data import layer 90 automatically or manually imports health care recipient information for each client. The course assignment layer 92 automatically or manually assigns the courses and/or tests to the health care recipients or groups of health care recipients for each client. The reward management layer 94 assigns rewards for a performance of one or more courses and/or tests. The course administration layer 96 electronically administers the courses and/or tests to the health care recipients based on the assignments. The data export layer 98 generates reports and notifications to the administrators, the clients, and/or the heath care recipients based on the data stored in the HEI datastore 38 (FIG. 2). As can be appreciated, each layer can be implemented as one or more sub-modules of the health care education management module 40.

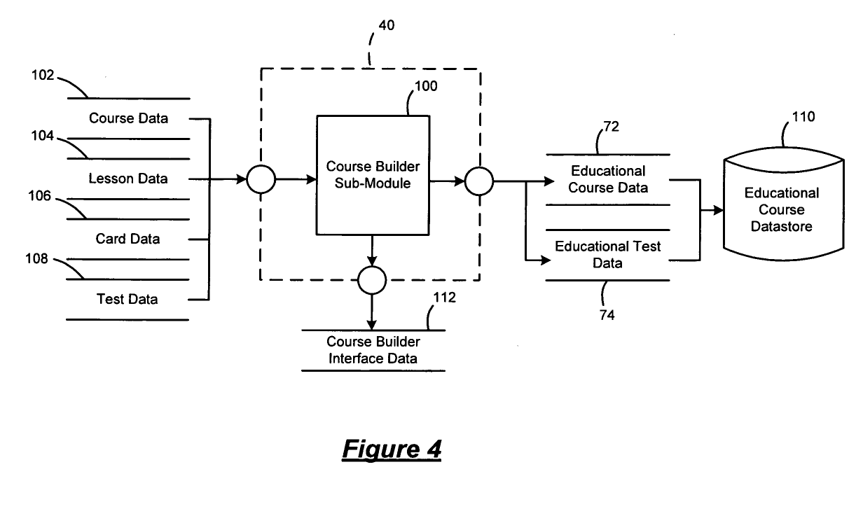

Referring now to FIG. 4, a dataflow diagram illustrating a course builder sub-module 100 of the health care education management module 40 is shown. The course builder sub-module 100 operates based on configuration data 46 (FIG. 2) received as course data 102, lesson data 104, card data 106, and test data 108. The course builder sub-module 100 is operable to view, add, edit, delete, and/or copy new health care educational courses and/or educational tests. The course builder sub-module 100 can configure each educational course to include one or more lessons and each lesson can be comprised of one or more electronic cards.

For example, a first health care educational course can include two lessons, a “Diabetes” lesson and a “Heart Disease” lesson. The “Diabetes” lesson can be comprised of ten electronic cards and the “Heart Disease” lesson can be comprised of eleven electronic cards. Each electronic card can be a particular interface directed to an element or topic of the lesson. For example, the card can be directed to a topic such as, but not limited to, a basic principle, detailed information about the principle, video display supporting the principle, the principle in bullet point form, action steps for the health care recipient, an interactive quiz, an interactive exercise, success stories of other individuals, common questions and answers, helpful resources or web links, and an introduction to a test. The course builder sub-module 100 additionally or alternatively can add, edit, delete, and/or copy new health care educational tests. The educational tests can be assigned to a particular course, a lesson, and/or group thereof. Once the educational courses and/or educational tests are created or modified, educational course data 72 and/or educational test data 74 are stored in an educational course datastore 110 of the HEI datastore 38 (FIG. 2).

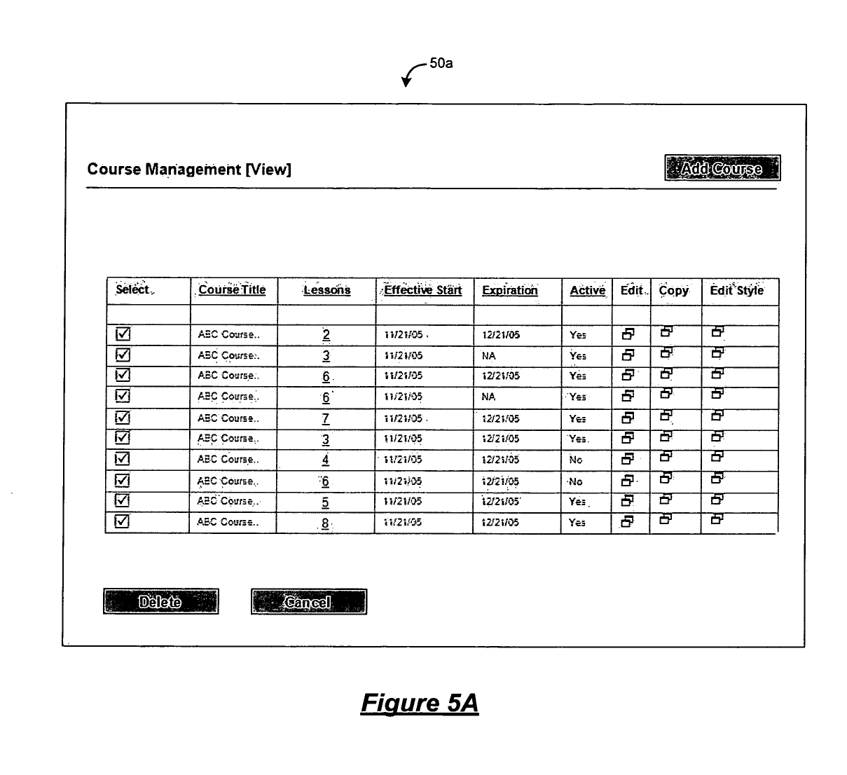

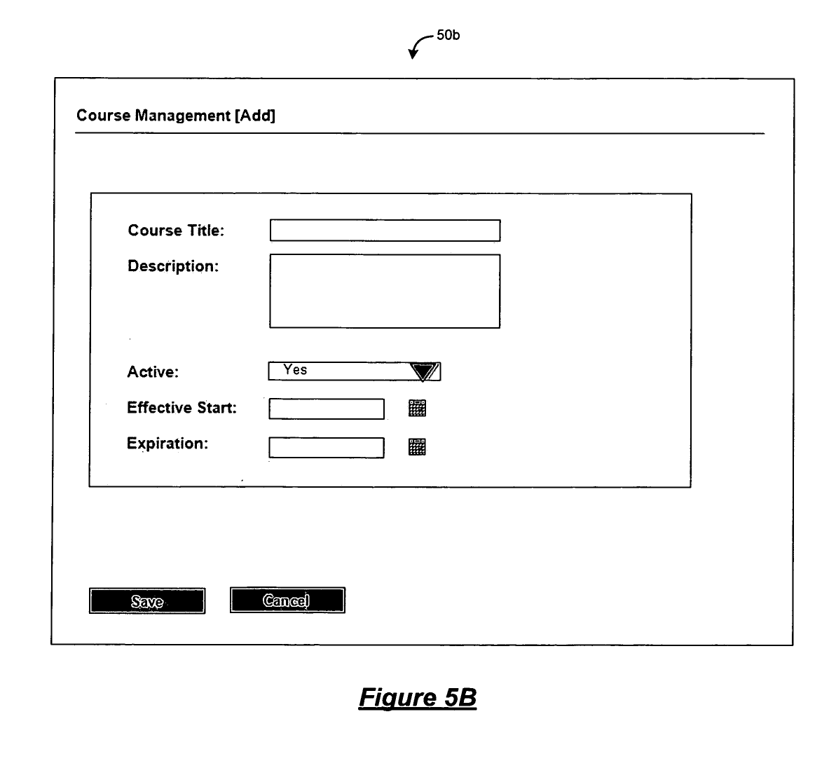

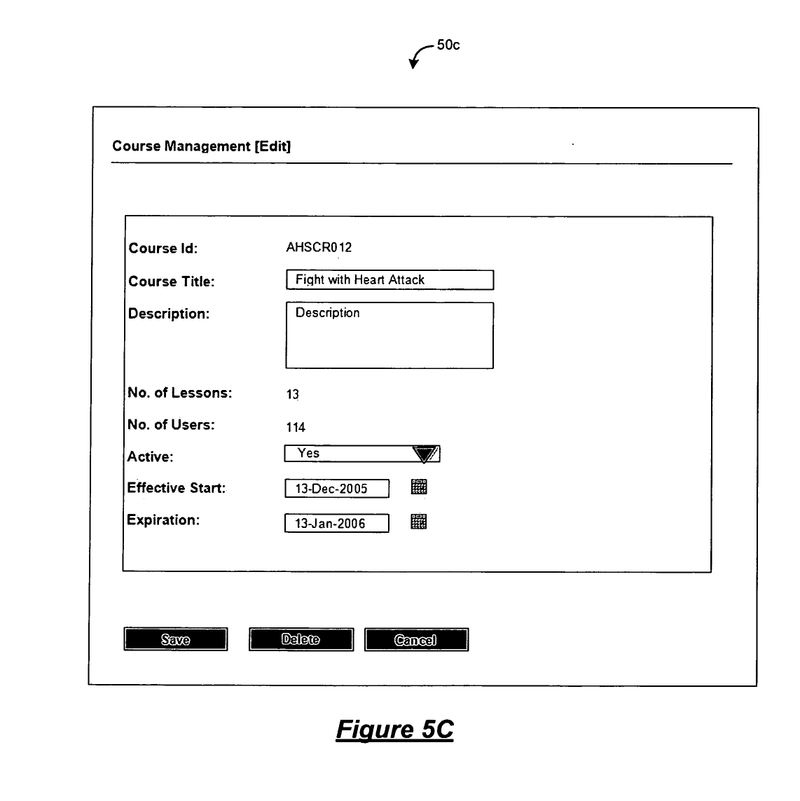

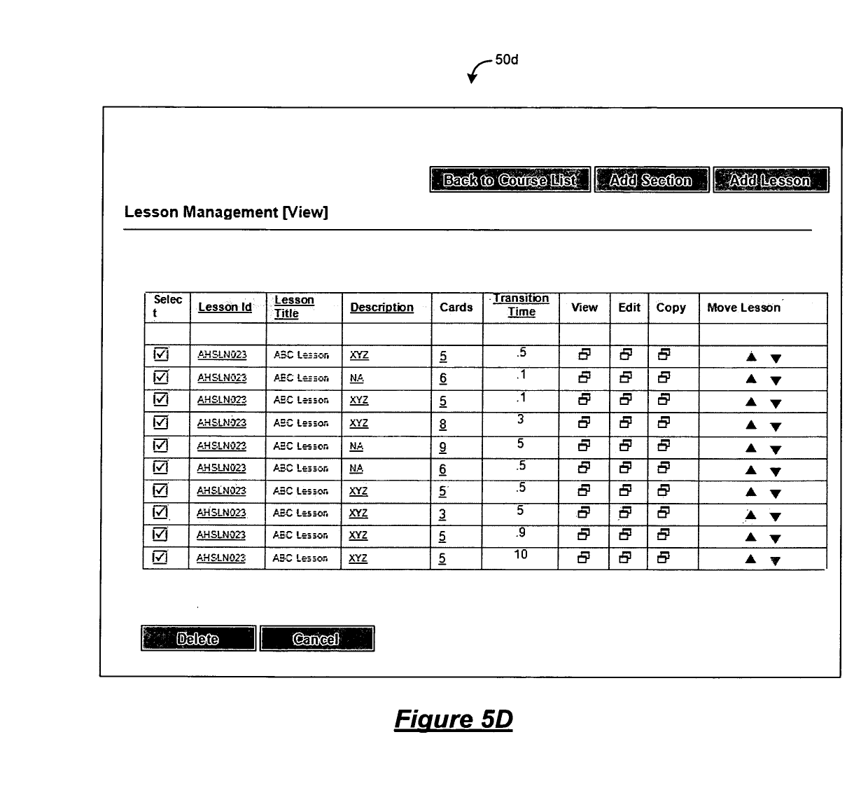

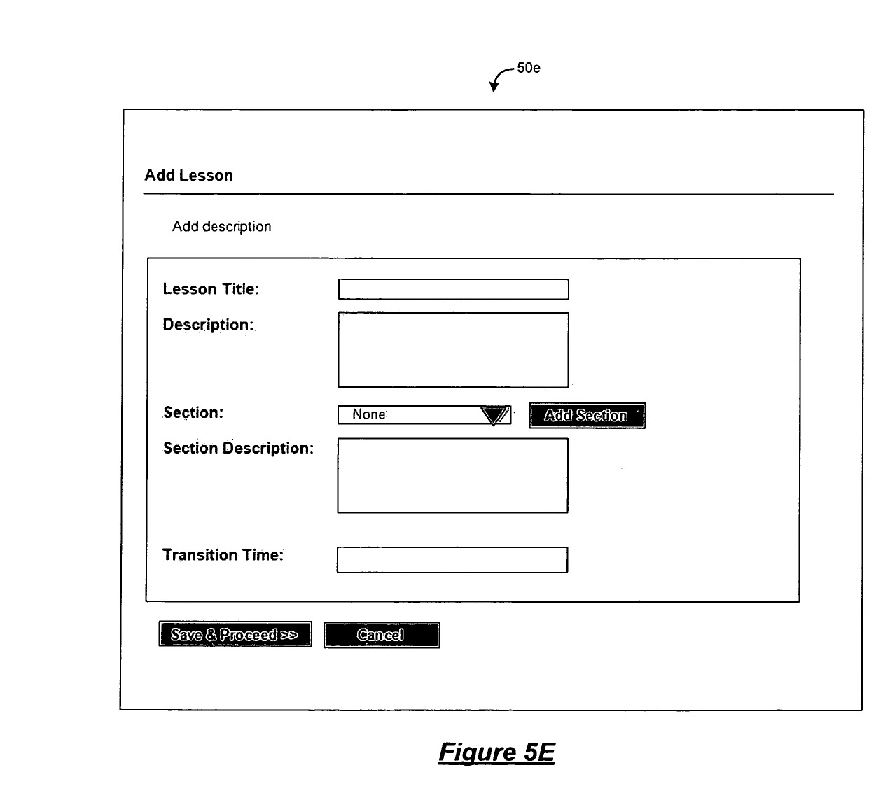

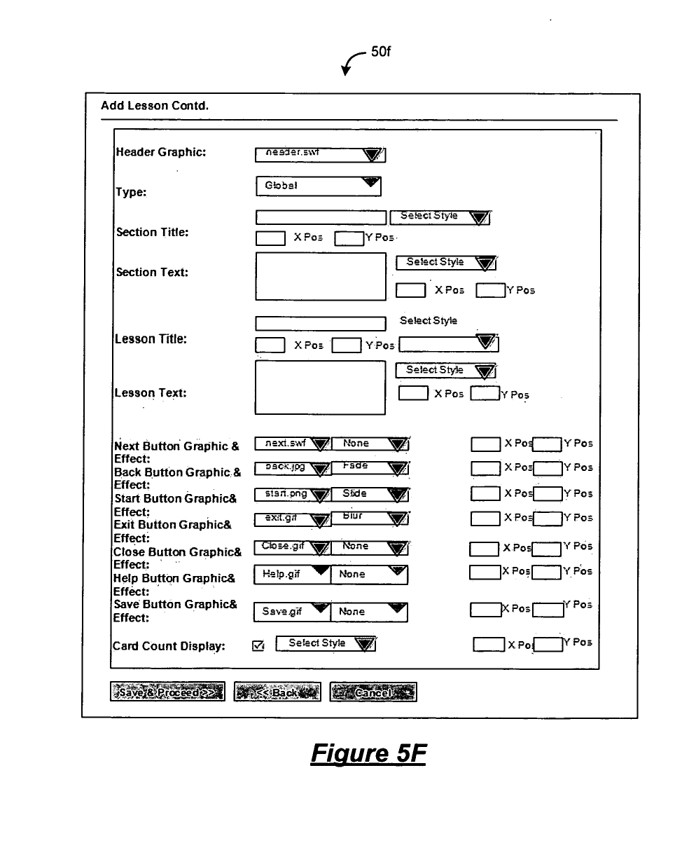

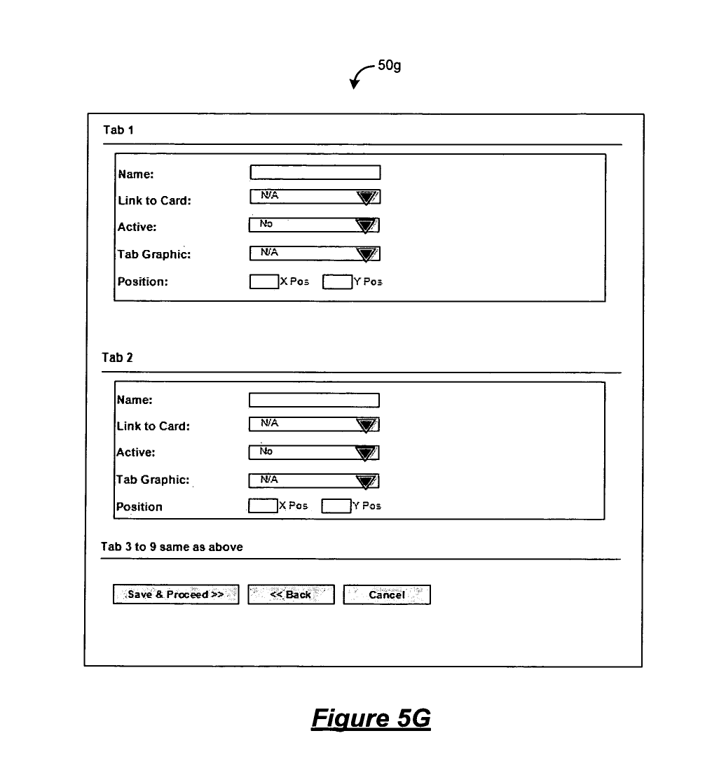

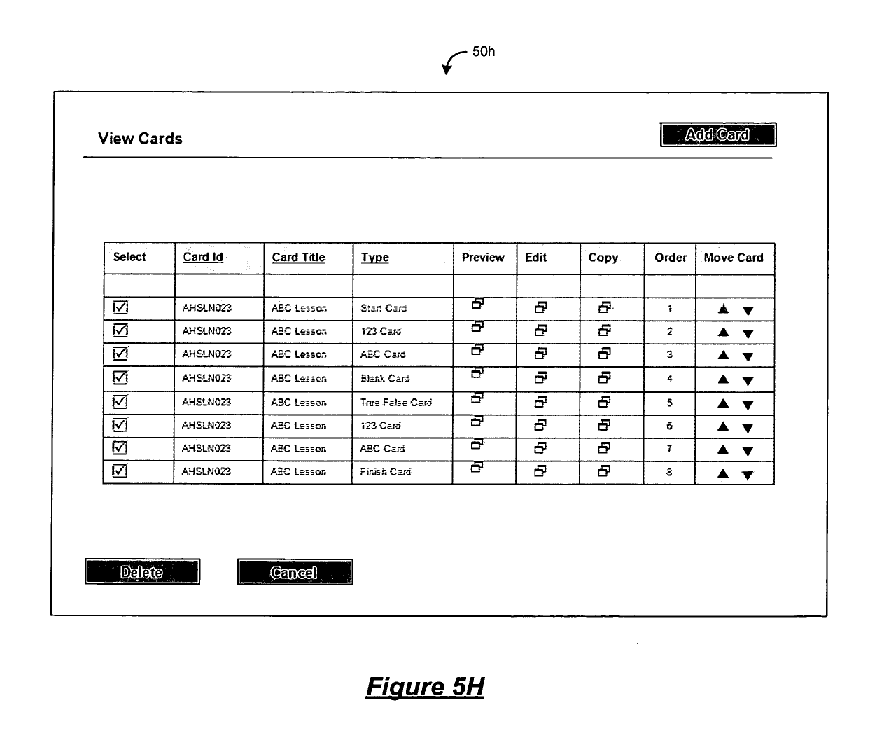

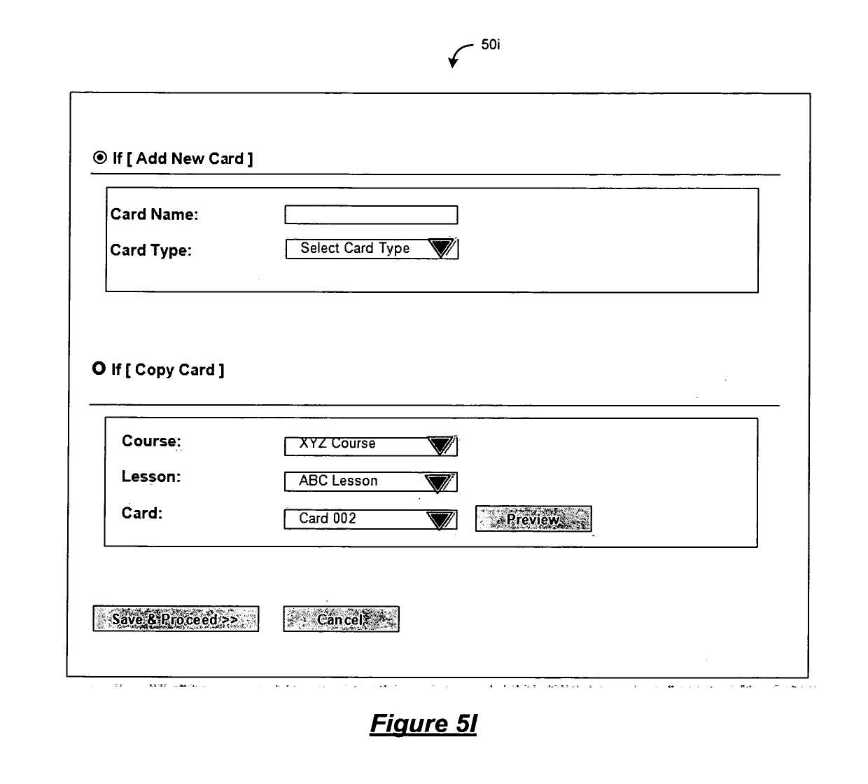

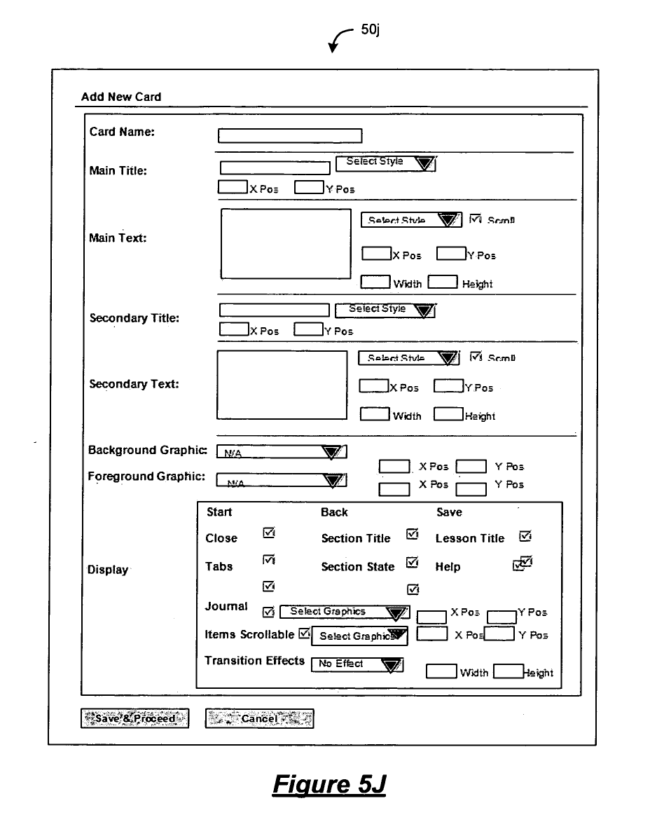

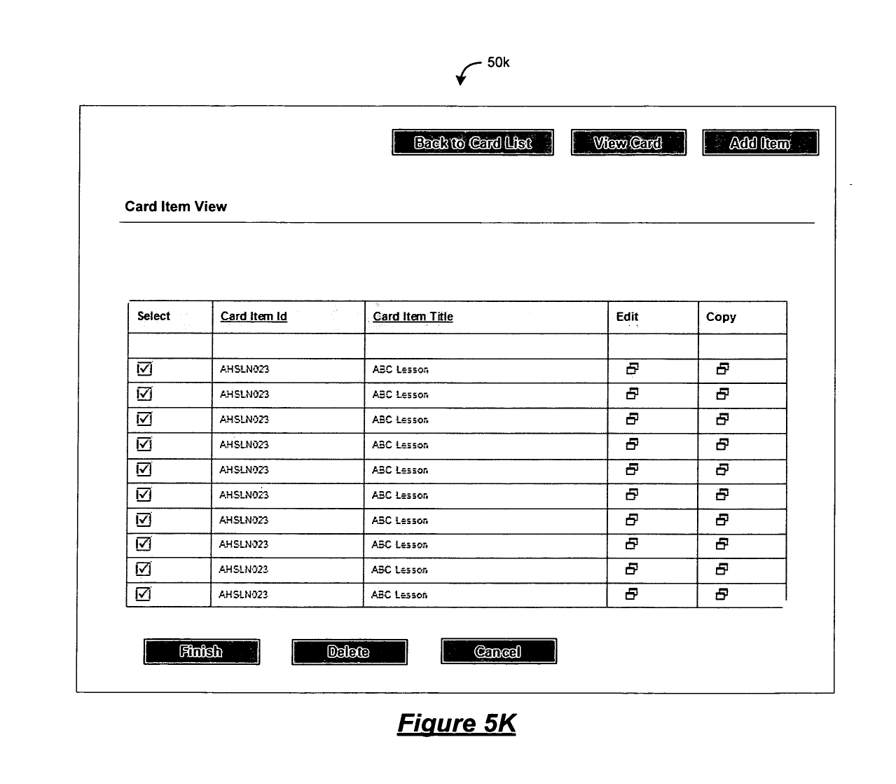

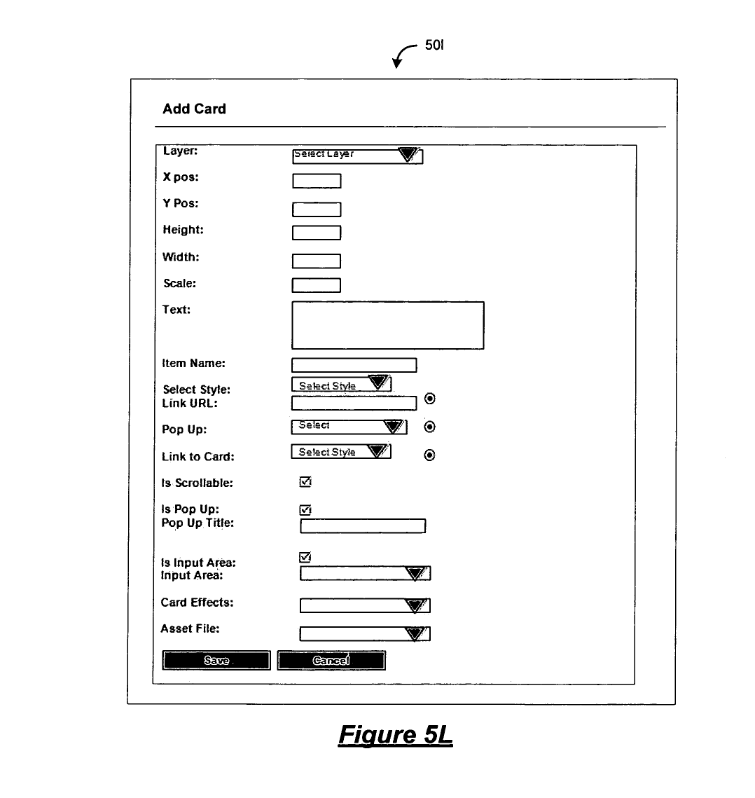

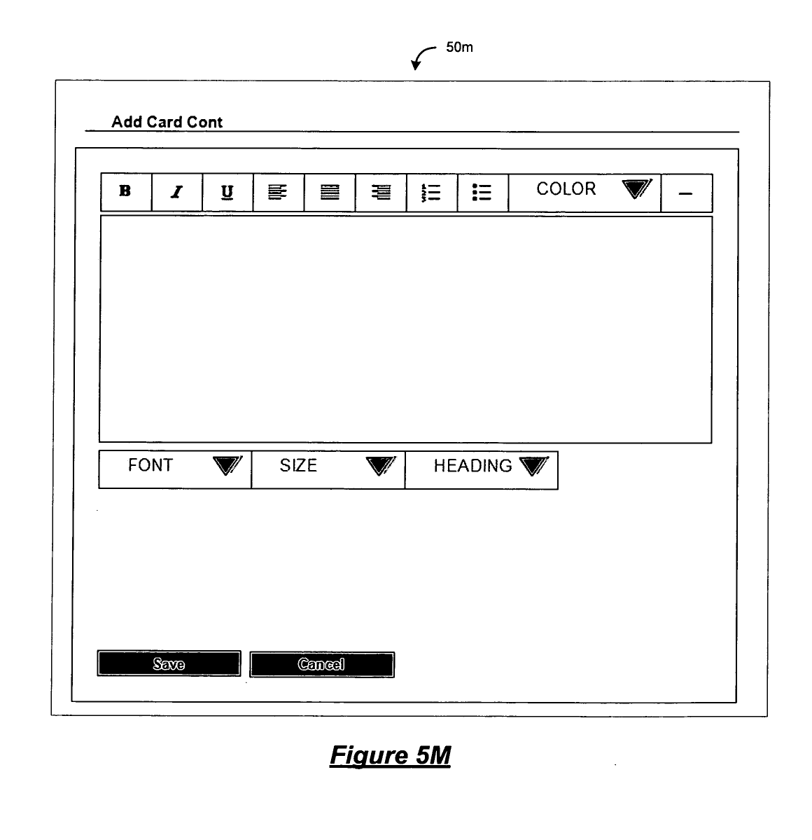

The course builder sub-module 100 generates course builder interface data 112 for use by the interface management module 42 (FIG. 2) to generate one or more course builder interfaces 50 (FIG. 2). Exemplary course builder interfaces are shown in FIGS. 5A-50. In particular, FIGS. 5A-5C illustrate course builder interfaces 50a-50c that are used to view, add, edit, and/or copy course data 102. FIGS. 5D-5G illustrate course builder interfaces 50d-50g that are used to view, add, edit, delete, and/or copy lesson data 104. FIGS. 5H-50 illustrate course builder interfaces 50h-50o that are used to view, add, edit, delete, and/or copy card data 106. In particular, FIGS. 5N and 50 illustrate course builder interfaces 50n and 50o that are used for creating various fonts and styles used in the creation of a particular card. The information entered into each course builder interface is translated into an electronic course form. In various embodiments, the electronic course form is based on a web programming language as discussed above.

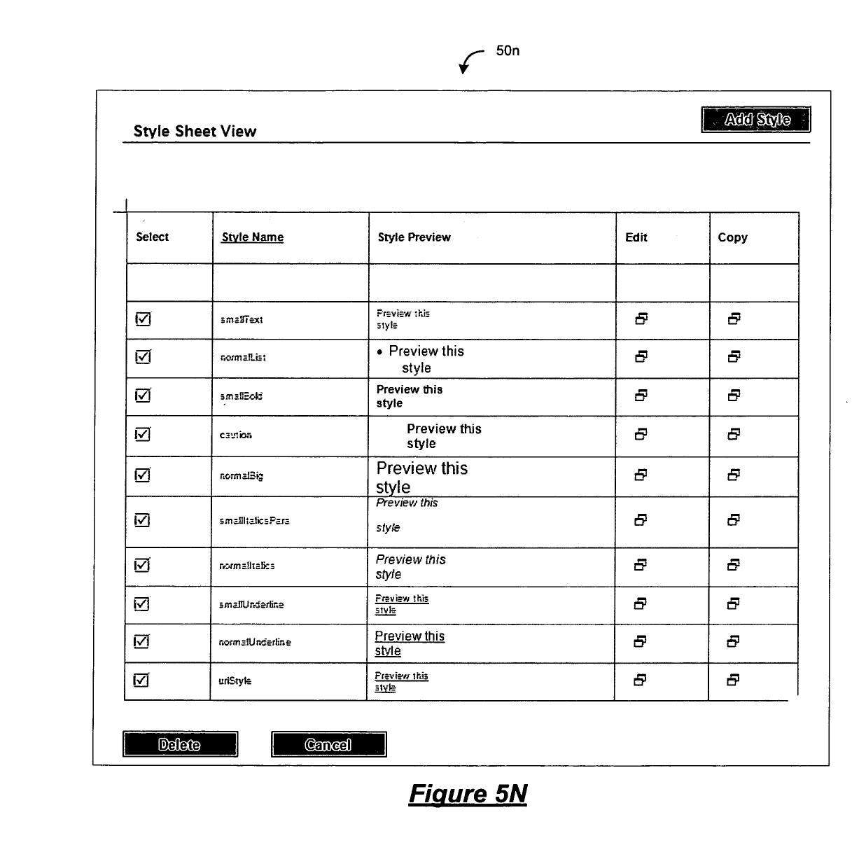

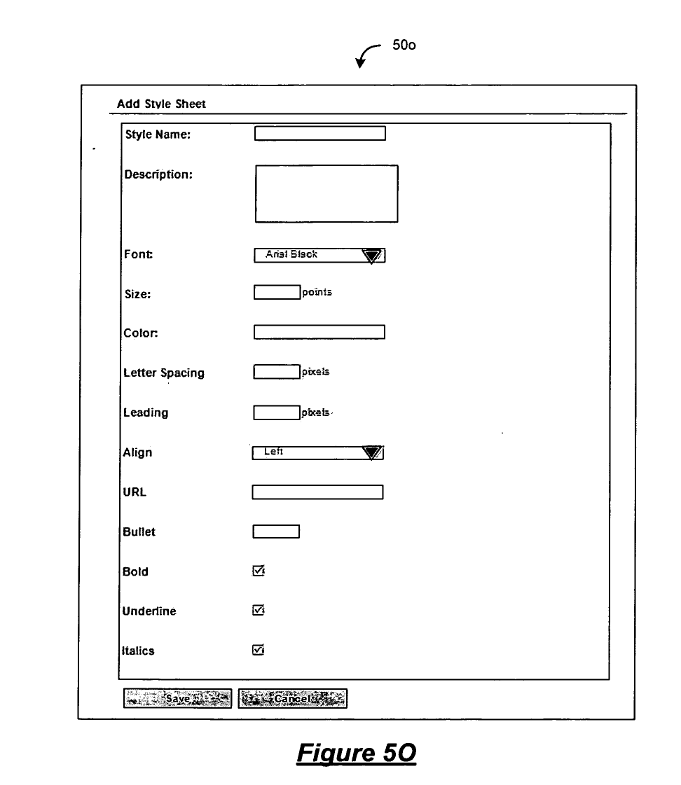

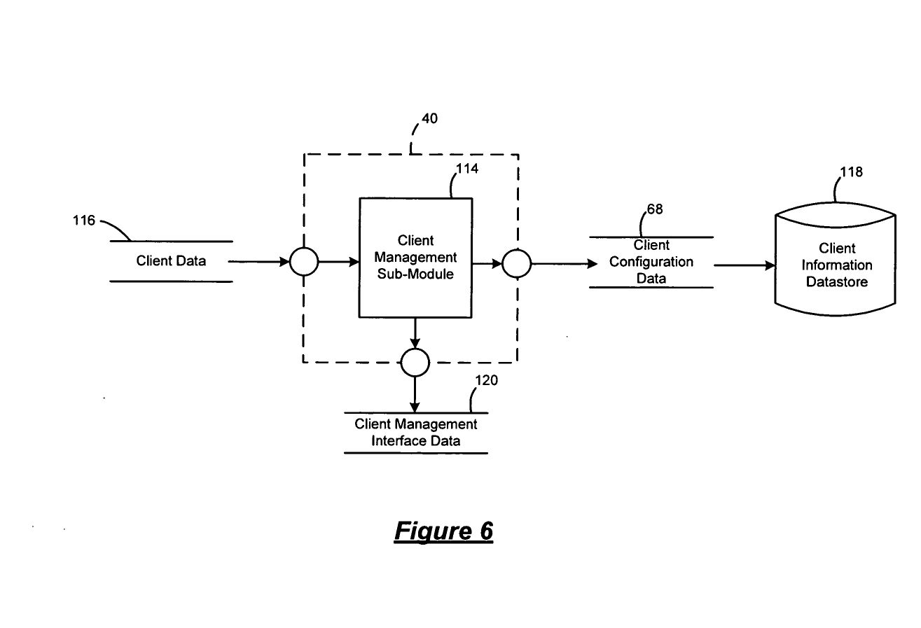

Referring now to FIG. 6, a dataflow diagram illustrating a client management sub-module 114 of the health care education management module 40 is shown. The client management sub-module 114 operates based on configuration data 46 (FIG. 2) received as client data 116. The client data 116 includes information about the client, such as, but not limited to, name, address, web URL, and activity. The client management sub-module 114 is operable to allow administrators to create, edit, and/or delete clients from the health care education management system 12 (FIG. 2). Once the clients are created or modified, client configuration data 68 is stored in a client information datastore 118 of the HEI datastore 38 (FIG. 2).

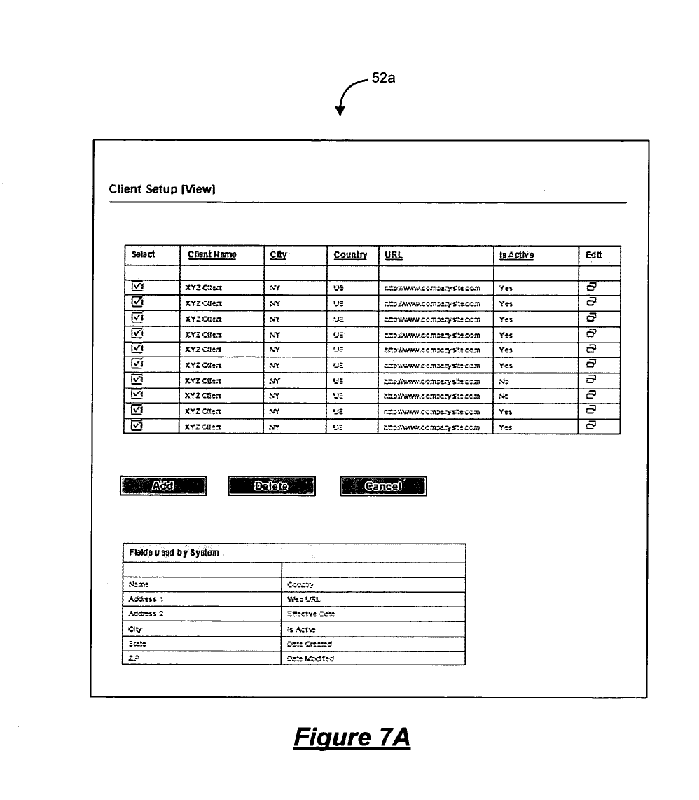

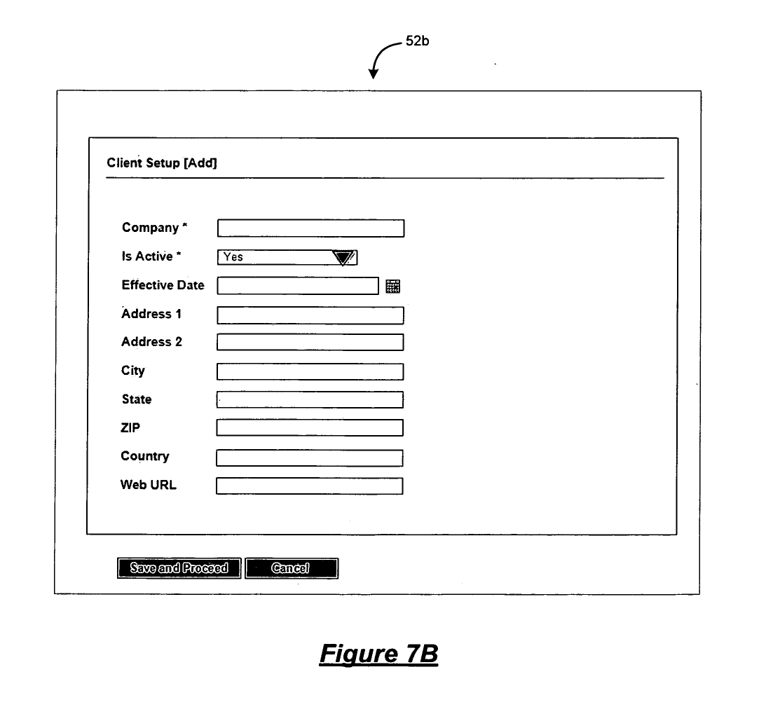

The client management sub-module 114 generates client management interface data 120 for use by the interface management module 42 (FIG. 2) to generate one or more client management interfaces 52 (FIG. 2). Exemplary client management interfaces are shown in FIGS. 7A-7E. In particular, FIGS. 7A-7C illustrate client management interfaces 52a-52c that are used to create, edit, and/or delete clients by accepting client data 116. FIGS. 7D and 7E illustrate client management interfaces 52d and 52e that are used to edit the client data 116 required to be entered for each client. In particular, information fields can be selected and deselected in the client management interface 52d shown in FIG. 7D. New information fields can be manually created via the client management interface 52e in FIG. 7E. FIG. 7F illustrates a client management interface 52f that is used to configure permissive access to interfaces of the health care education management system 12 for the clients, administrators, and health care recipients. For example, a client may be given permission by the administrator to view and update the course assignment interfaces 56 (FIG. 2) and the reward management interfaces 58 (FIG. 2).

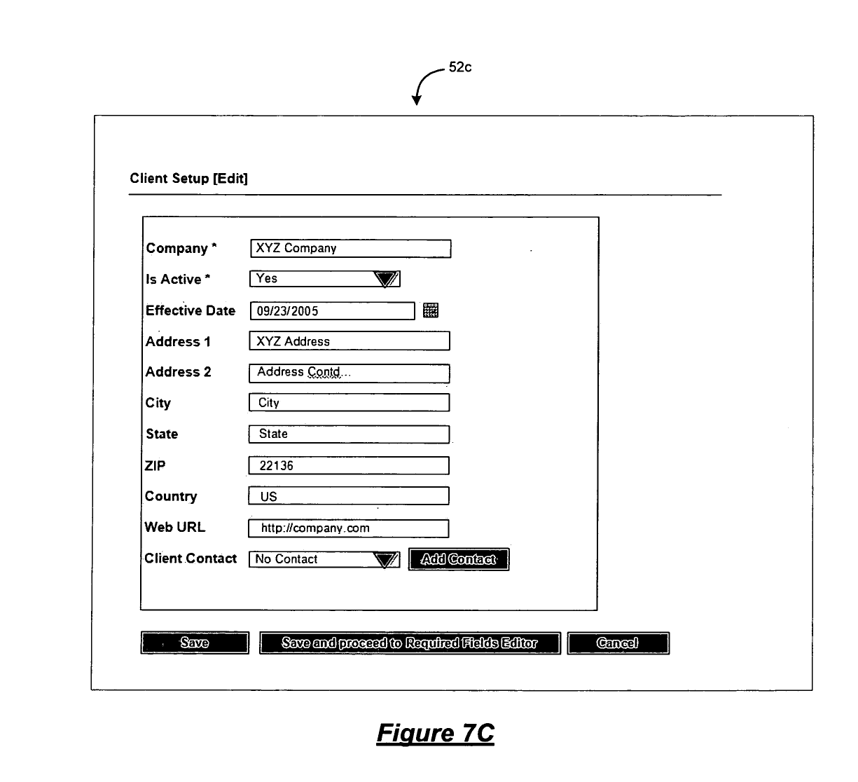

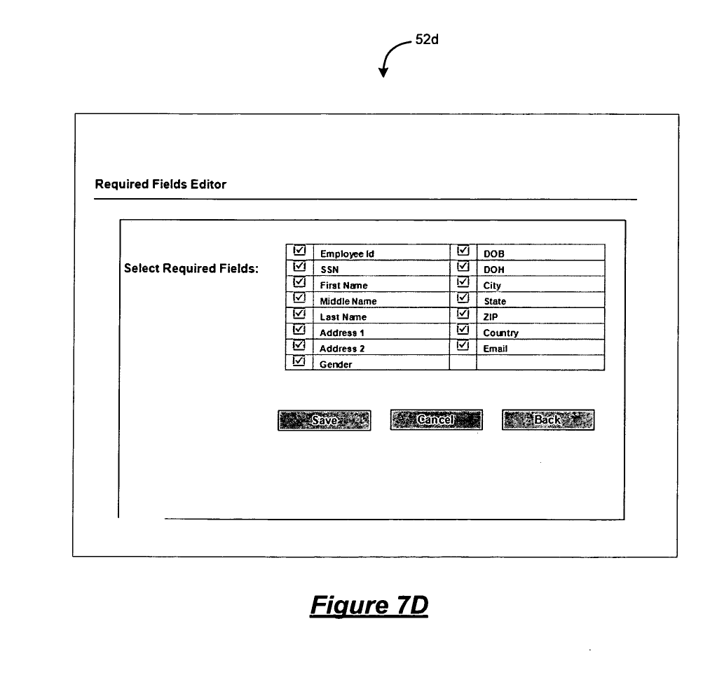

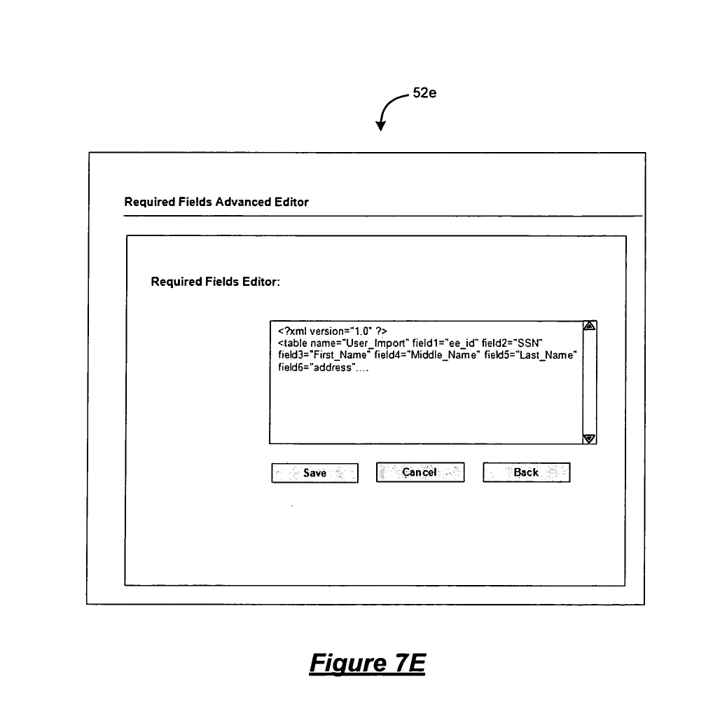

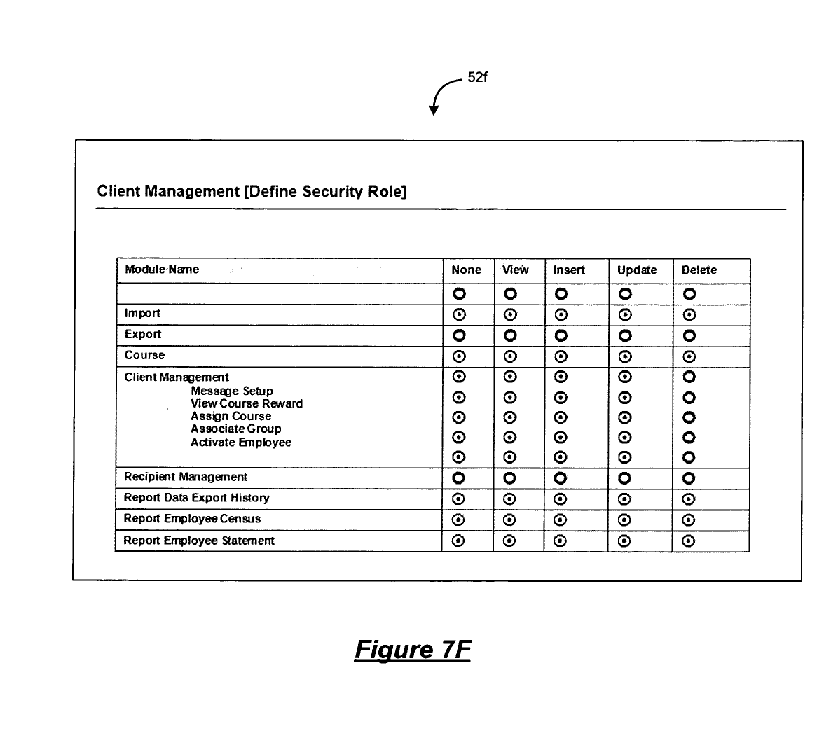

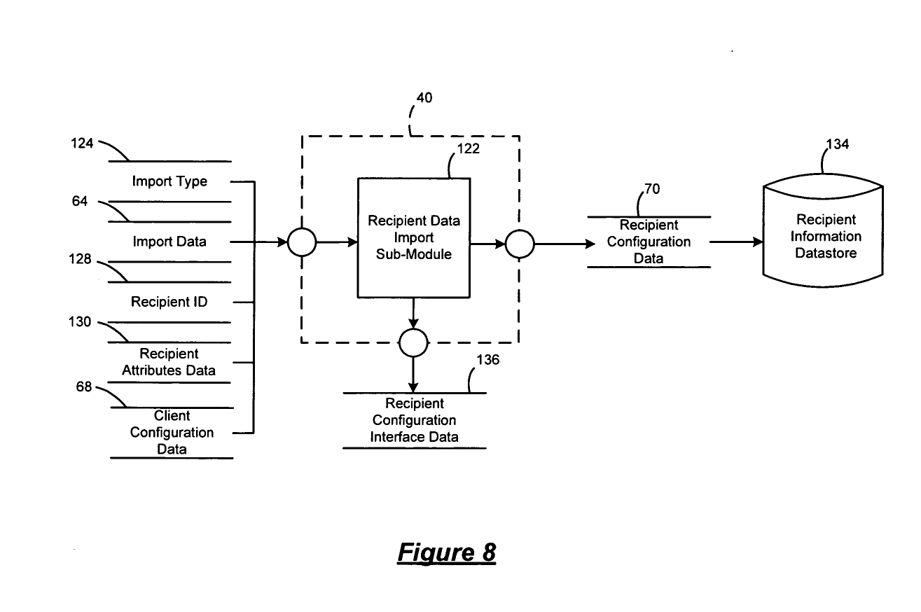

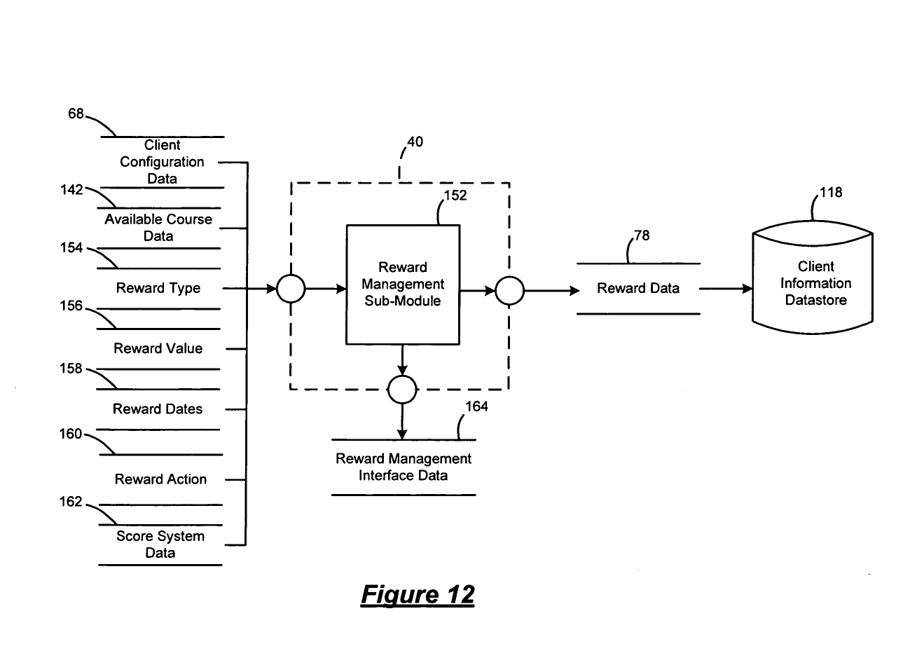

Referring now to FIG. 8, a dataflow diagram illustrating a recipient data import sub-module 122 of the health care education management module 40 is shown. The recipient data import sub-module 122 operates based on configuration data 46 (FIG. 2) received as import type 124, import data 64, recipient identification 128, recipient attributes data 130, and client configuration data 68. The recipient data import sub-module 122 is operable to automatically or manually import the required health care recipient information for each client configured in the system 12 (FIG. 12). Such health care recipient information can include, but is not limited to, name, address, recipient identification number, email address, work department, date of birth, and gender.

In various embodiments, if the import type 124 indicates “manual,” the import data 54 is read in from a manually selected file and parsed. If the import type 124 indicates “automatic,” the import data 54 is automatically read in and parsed. In various embodiments, the recipient data import sub-module 122 can be configured to automatically import the data 64 at a scheduled time, when a new import file is detected, or upon command. As can be appreciated, the import data 64 can be formatted according to a parsable predefined format including, but not limited to, a comma separated variable (CSV) format, a tab separated variable (TSV) format, and an extensible markup language (XML) format.

Once the import data is read in, the information about the health care recipients can be edited by manually entering or selecting the recipient identification 128 and/or the associated recipient attributes data 130 via a recipient configuration interface 54 (FIG. 2). Once the health care recipients for each client are created or data for the recipients is modified, recipient configuration data 70 is stored in a recipient information datastore 134 of the HEI datastore 38 (FIG. 2).

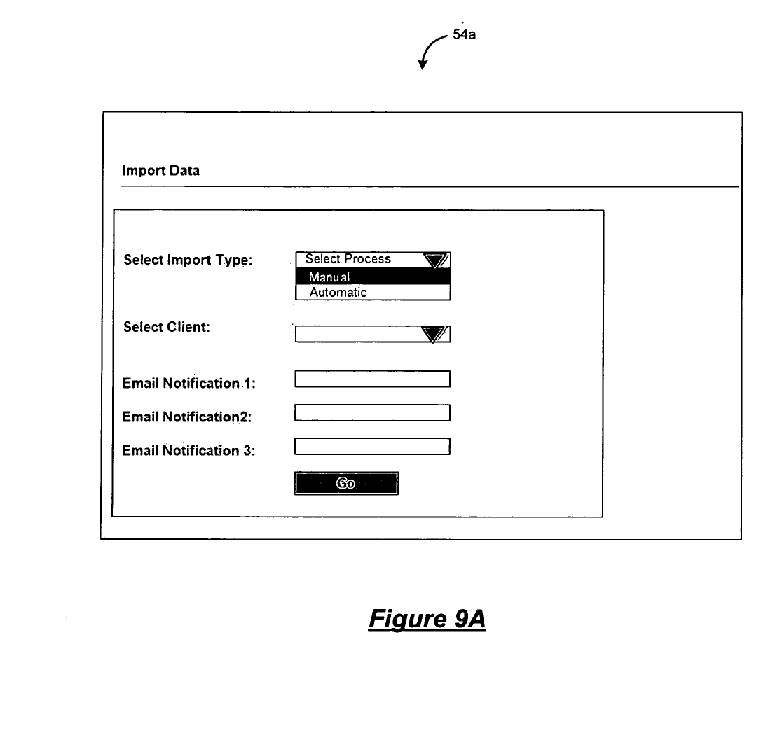

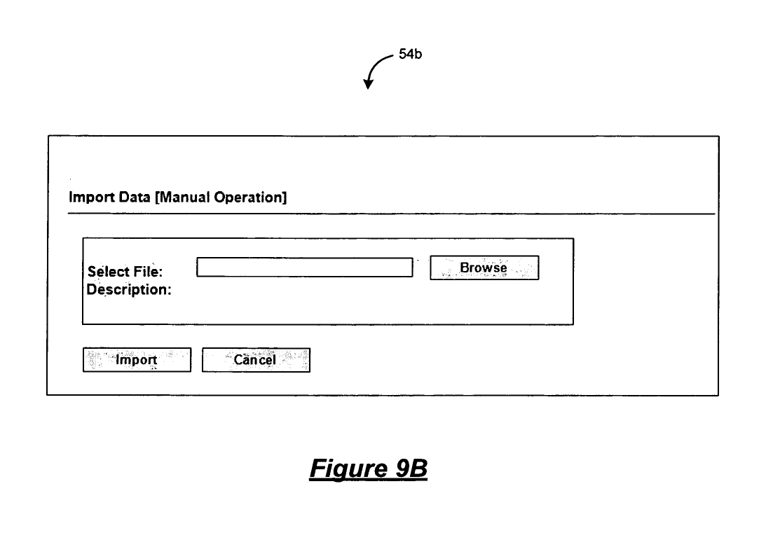

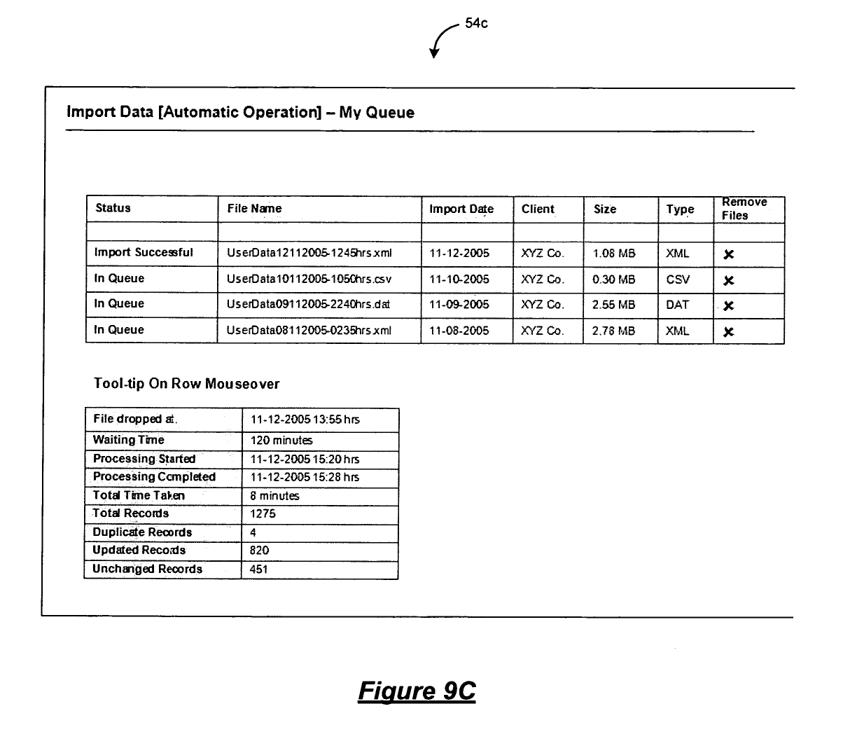

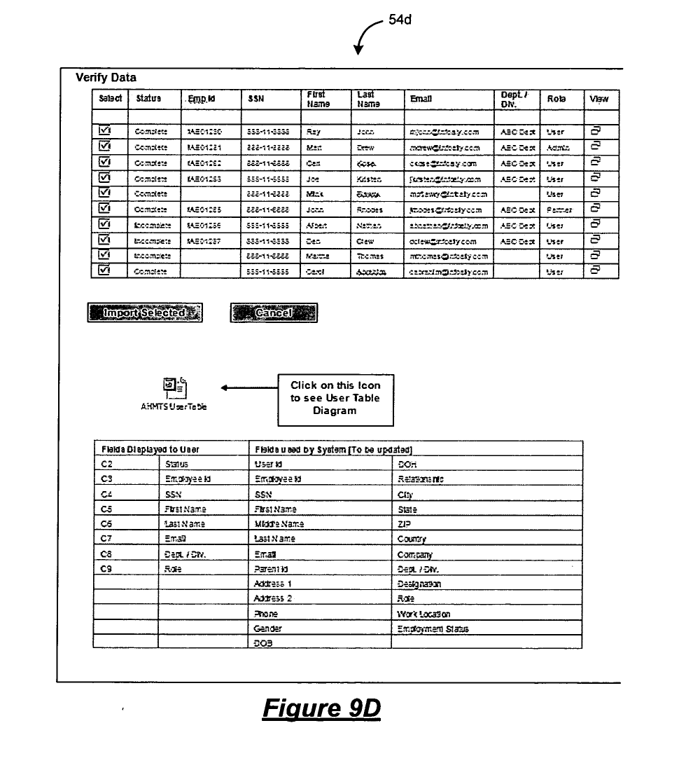

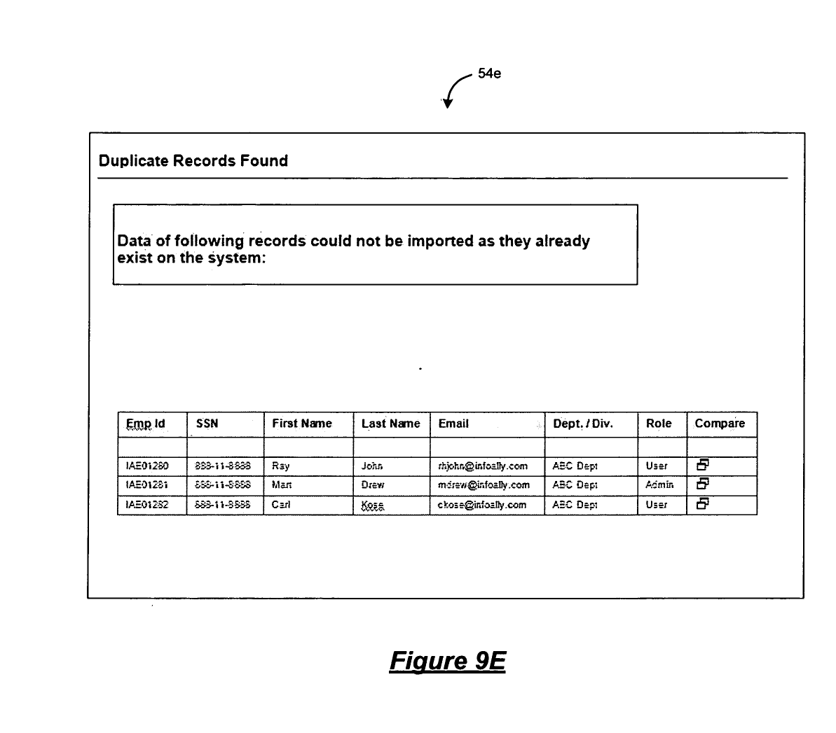

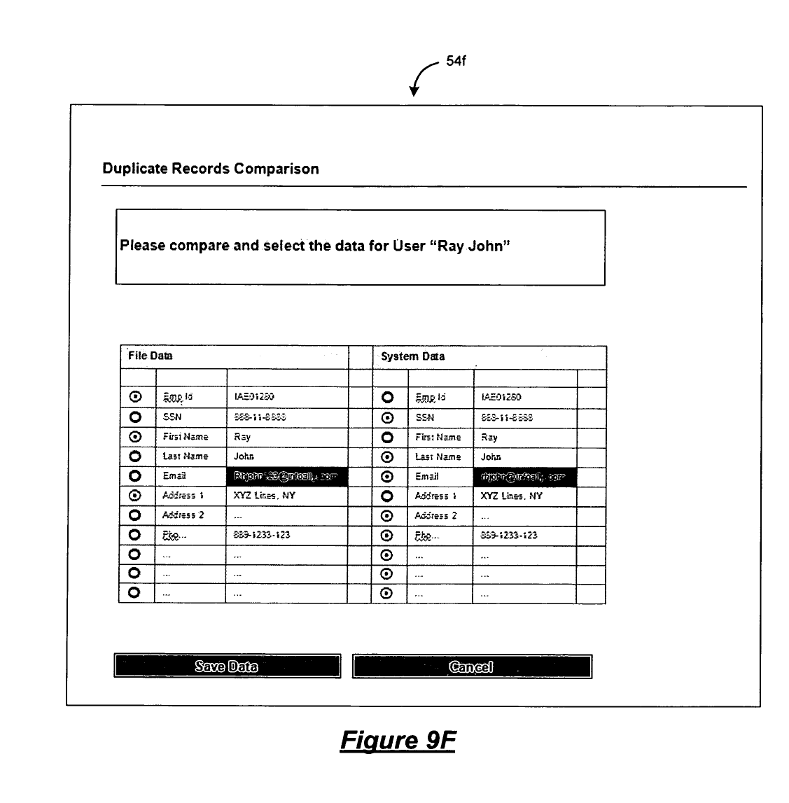

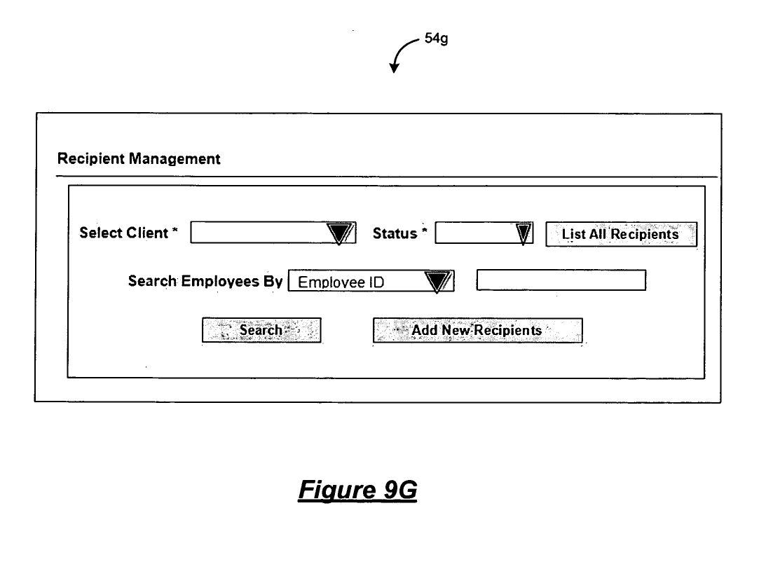

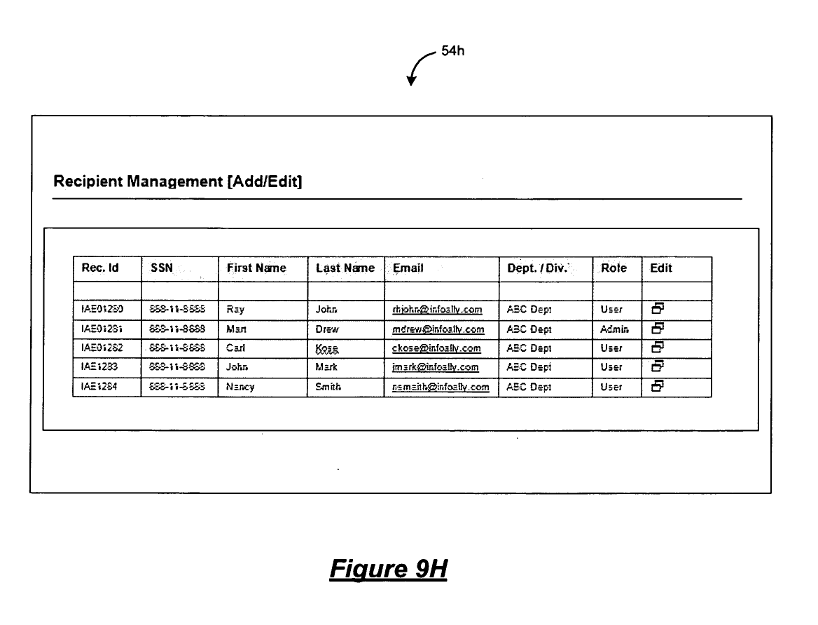

The recipient data import sub-module 122 generates recipient configuration interface data 136 for use by the interface management module 42 (FIG. 2) to generate one or more recipient configuration interfaces 54 (FIG. 2). Exemplary recipient configuration interfaces 54a-54g are shown in FIGS. 9A-9G. In particular, FIG. 9A illustrates a recipient configuration interface 54a that is used to select the import type 124. FIGS. 9B illustrates a recipient configuration interface 54b that is used to select a file for the manual import. FIGS. 9C illustrates a recipient configuration interface 54c that is used to automatically import recipient information into the system. FIGS. 9D-9F illustrate recipient configuration interfaces 54d-54f that can be used to verify the import data 64 either automatically or manually. FIGS. 9G and 9H illustrate hrecipient configuration interfaces 54g and 54h that can be used to modify the recipient configuration data 70.

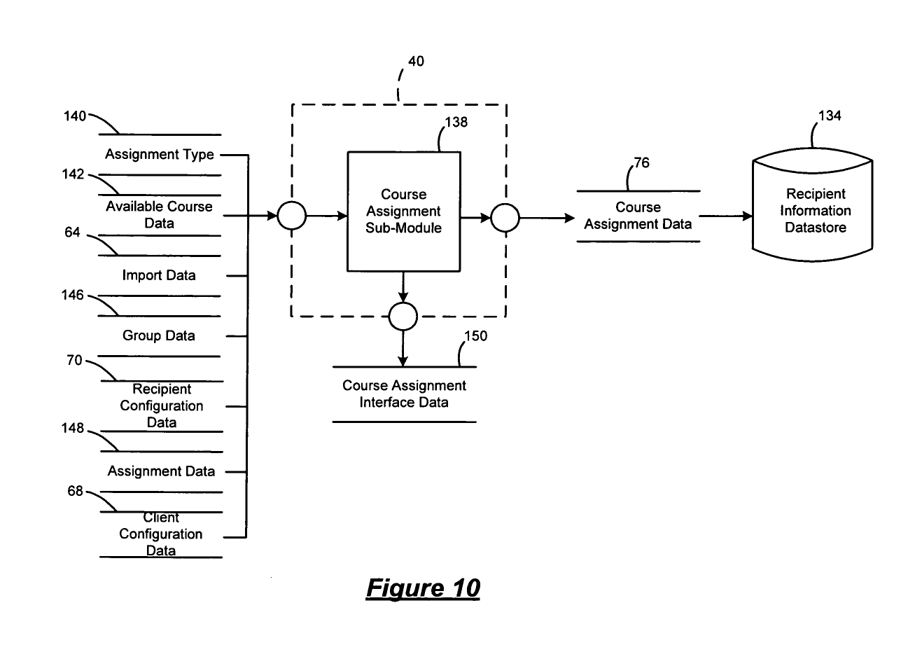

Referring now to FIG. 10, a dataflow diagram illustrating a course assignment sub-module 138 of the health care education management module 40 is shown. The course administration sub-module 166 operates based on configuration data received as assignment type 140, available course data 142, import data 64, group data 146, recipient configuration data 70, client configuration data 68, and assignment data 148. The course assignment sub-module 138 is operable to automatically or manually assign courses, lessons, and/or groups thereof to the health care recipients for each client. Course assignment data 76 is stored in the recipient information datastore 134.

For example, if the assignment type 140 indicates “manual,” available courses and/or lessons 142 chosen by the client can be assigned to individual health care recipients or groups of health care recipients by manually entering group data 146 and assignment data 148. For example, an administrator may select an available course or a group of courses from a listing in the course assignment interface. The administrator may then select a health care recipient to assign the course to. The course assignment module stores the course assignment data 76 in the recipient information datastore 134.

If the assignment type 140 indicates “automatic,” import data 64 is automatically read in or manually entered and automatically parsed. Such import data 64 can include health information about various health care recipients. Such health information may include, but is not limited to, health care carrier claims information and health risk assessment information. In the case of the health care carrier claims information, the import data 64 is parsed for a data field indicating the cause for the claim (i.e., Current Procedural Terminology (CPT) codes). The data field is then used to assign available courses to an individual health care recipient, or a group of health care recipients. For example, import data from a CPT code field is parsed and compared to a predetermined listing that associates known CPT codes with the available courses. If the CPT code matches one of the known CPT codes from the list and a course is associated with that known CPT, the course is assigned to the health care recipient.

In the case of the health risk assessment information, the course assignment sub-module 138 parses the import data 64 for a designated field that may indicate or be associated with a particular health condition (i.e., obesity, diabetes, heart risk). The course assignment sub-module 138 then assigns courses and/or lessons to individual healthcare recipients or a group of health care recipients based on the particular health conditions. For example, import data from a height field and a weight field is parsed and compared to a predetermined body mass index to determine if the health care recipient should be assigned to an available Obesity Course. If the individual qualifies, the Obesity Course is assigned.

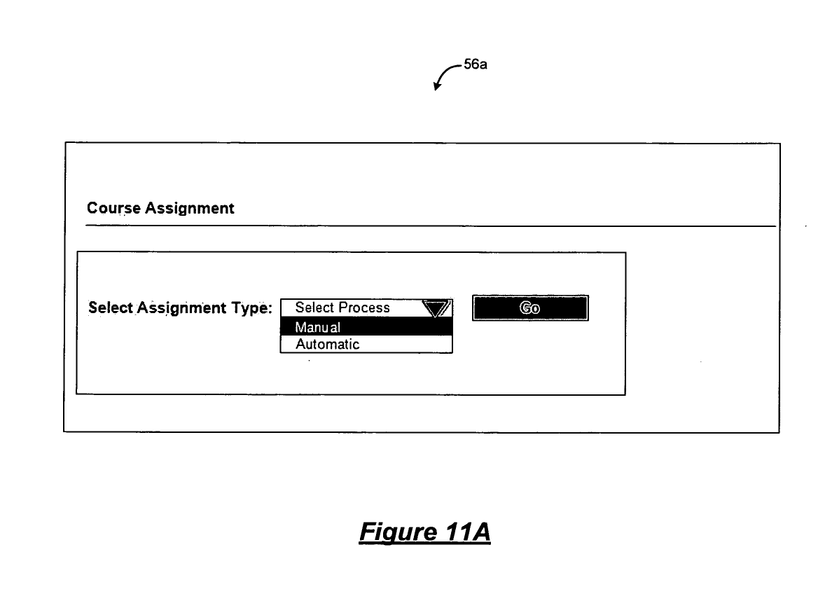

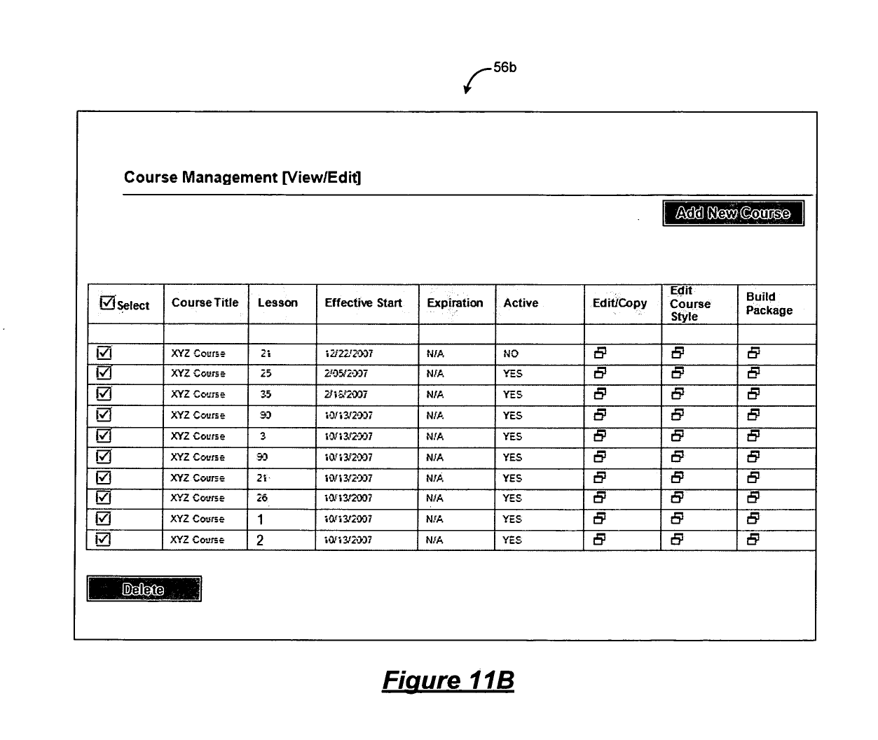

The course assignment sub-module 138 generates course assignment interface data 150 for use by the interface management module 42 (FIG. 2) to generate one or more course assignment interfaces 56. Exemplary course assignment interfaces are shown in FIGS. 11A and 11B. In particular, FIG. 11A illustrates a course assignment interface 56a that is used to select the assignment type 140. FIG. 11B illustrates a course assignment interface 56b that is used to manually add, edit, and/or delete course assignments, as well as group courses and/or lessons into packages.

Referring now to FIG. 12, a dataflow diagram illustrating a reward management sub-module 152 of the health care education management module 40 is shown. The reward management sub-module 152 operates based on configuration data 46 (FIG. 2) received as client configuration data 68, available course data 142, reward type 154, reward values 156, reward dates 158, reward action 160, and score system data 162. The reward management sub-module 152 is operable to assign rewards to health care recipients of the clients based on an expected performance of a course, a lesson, and/or a test.

For example, reward types 154 can be, but are not limited to: monetary rewards with a corresponding reward value 156 that can be deposited to a health care spending account or paid out in a pay check; health related gift prizes, such as running shoes, a sports watch, and a gym membership; points that can be used to purchase prizes; and employment incentives, such as a personal day off. The reward dates 158 indicate the dates of eligibility for the type of reward. The reward action 160 indicates how the reward should be distributed. The score system data 162 indicates the level of performance that must be achieved on the course, test, or sub-topics within the test before administering the reward. For example, a health care recipient must take a course and pass the corresponding test with a seventy-five percent or higher in order to receive the reward. In another example, questions of the test are divided into sub-topics. The score system data 162 can indicate a weakness level that must be achieved for each sub-topic in order to receive the reward. Once configured, the reward data 78 is stored in the client information datastore 118 of the HEI datastore 38 (FIG. 2).

The reward management sub-module 152 generates reward management interface data 164 for use by the interface management module 42 (FIG. 2) to generate one or more reward management interfaces 58 (FIG. 2). Exemplary reward management interfaces are shown in FIGS. 13A and 13B. In particular, FIG. 13A illustrates a reward management interface 58a that is used to add, edit, and/or delete reward data 78. FIG. 13B illustrates a reward management interface 58b that is used to select a reward for a course, a group of courses, a test, a group of tests, a test and a course, and/or combinations thereof (i.e., packages).

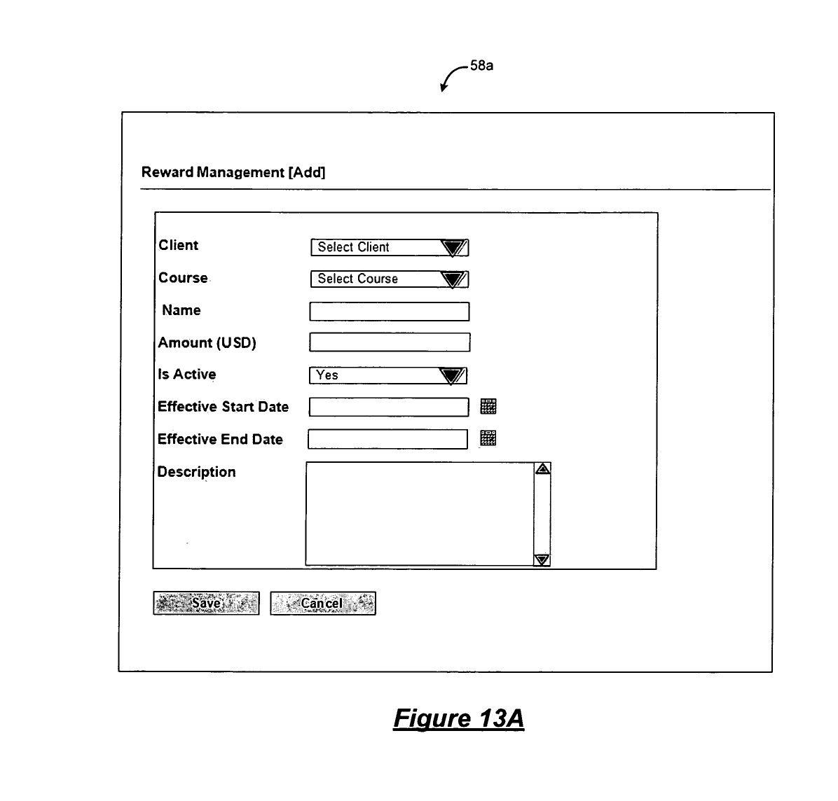

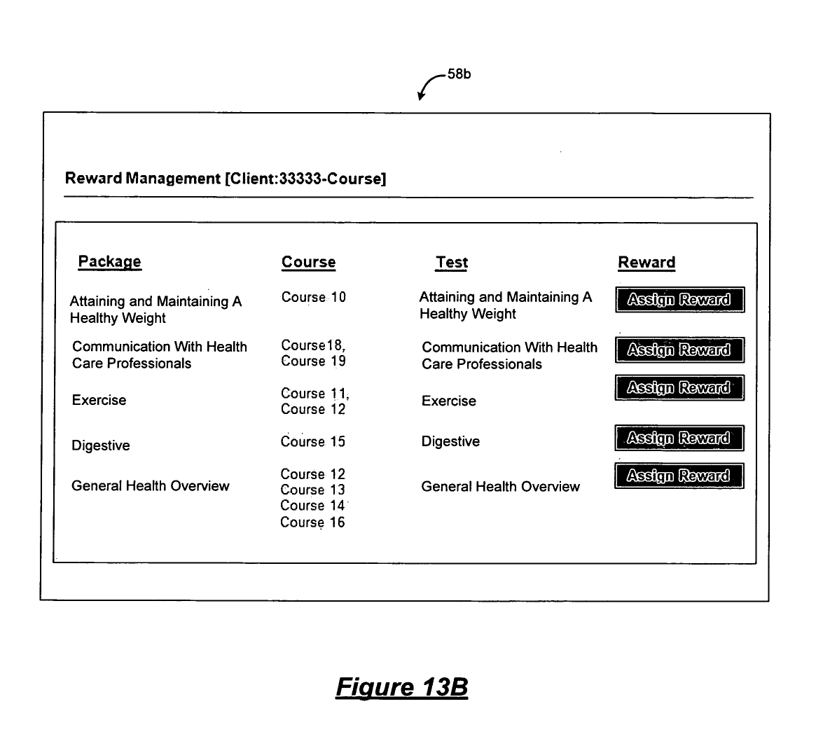

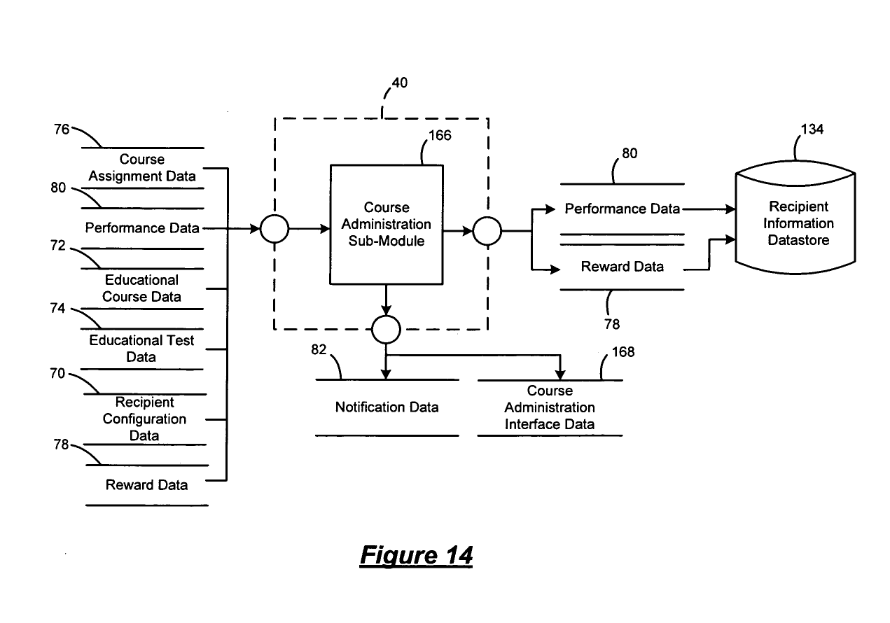

Referring now to FIG. 14, a dataflow diagram illustrating a course administration sub-module 166 of the health care education management module 40 is shown. The course administration sub-module 166 operates based on configuration data 46 (FIG. 2) received as course assignment data 76, performance data 80, reward data 78, educational course data 72, educational test data 74, and recipient configuration data 70. The course administration sub-module 166 is operable to electronically administer the courses, lessons, and/or tests to the health care recipients via the one or more course administration interfaces 62 (FIG. 2).

The health care recipients can be notified of the available courses and tests via notification data 82. In various embodiments, the course administration sub-module 166 can generate notification data 82 to various communication means including, but not limited to, electronic mail, electronic text messages, and electronic instant messages. The course administration sub-module 166 monitors the performance of the health care recipients in the assigned courses, lessons, and/or tests and stores the performance data 80 in the recipient information datastore 134. Based on the performance data 80, the course administration sub-module 166 stores the reward data 78 indicating which health care recipients qualify for the corresponding rewards.

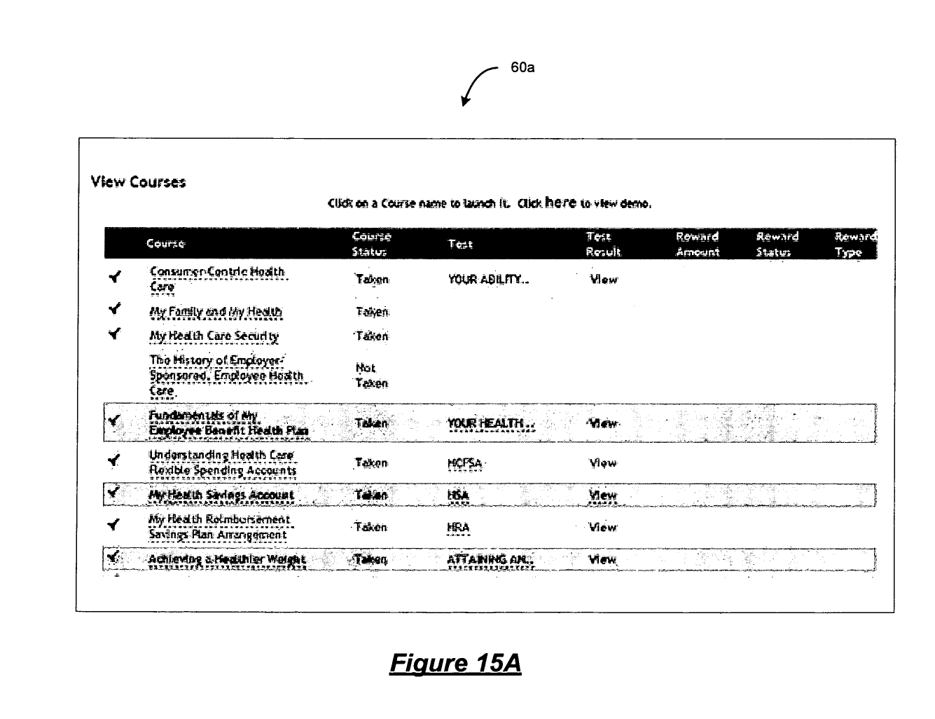

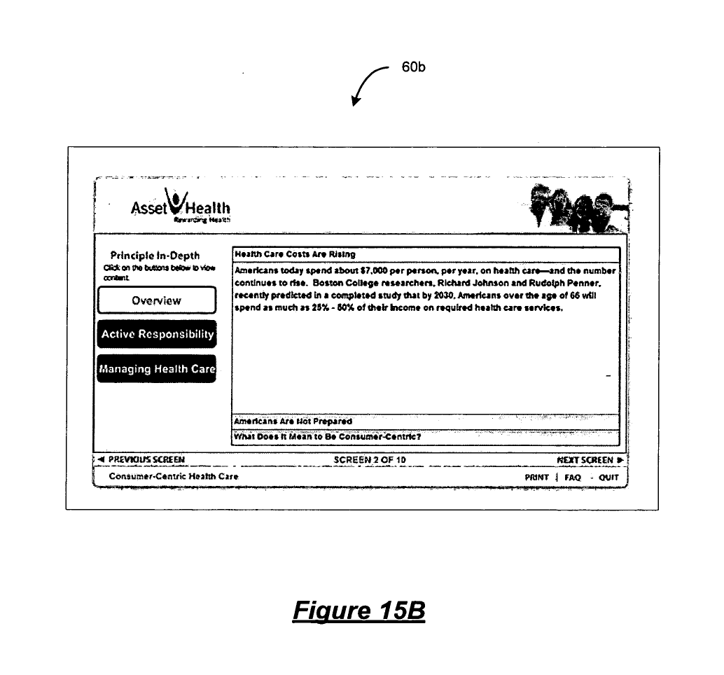

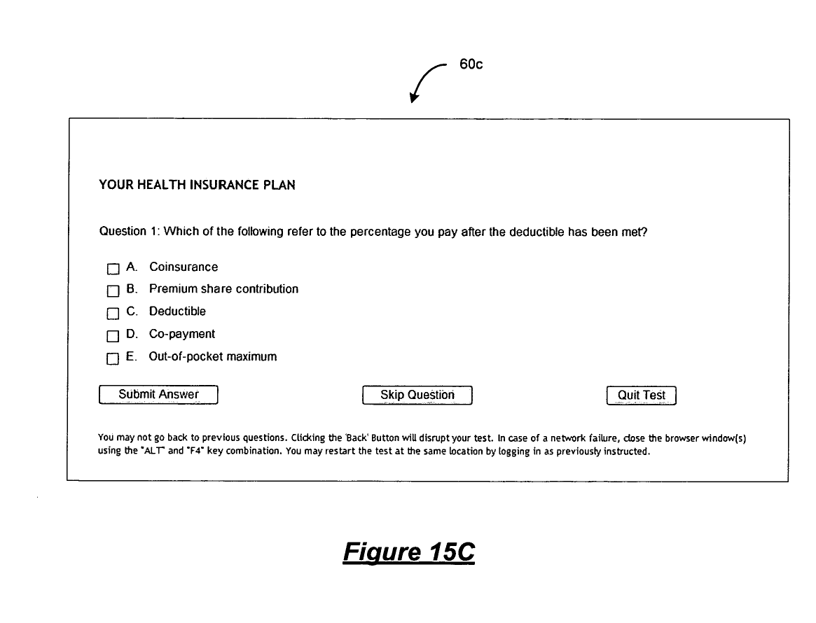

The course administration sub-module 166 generates course administration interface data 168 for use by the interface management module 42 (FIG. 2) to generate one or more course administration interfaces 60 (FIG. 2). Exemplary course administration interfaces are shown in FIGS. 15A-15C. In particular, FIG. 15A illustrates a course administration interface 60a used to list the particular courses, lessons, and/or tests that the health care recipient is eligible to take and the performance status of each. FIG. 15B illustrates a course administration interface 60b used to display the courses. FIG. 15C illustrates a course administration interface 60c used to display the tests.

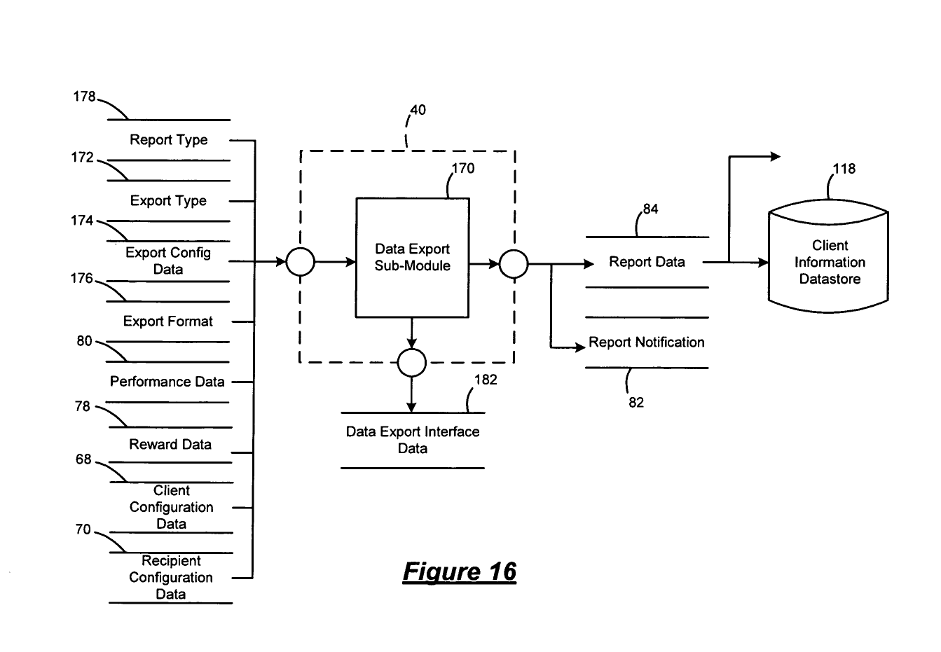

Referring now to FIG. 16, a dataflow diagram illustrating a data export sub-module 170 of the health care education management module 40 is shown. The data export sub-module 170 operates based on configuration data 46 (FIG. 2) received as export type 172, export configuration data 174, export format 176, performance data 80, reward data 78, reward type 178, client configuration data 68, and recipient configuration data 70. The data export sub-module 170 is operable to generate various reports for a client based on the performance data 80, the reward data 78, and the recipient configuration data 70 and to automatically or manually export the report data 84. Such reports may include, but are not limited to, an import history, a client listing, a data export history, a recipient census, and a recipient activity summary. The data export sub-module 170 can be configured to export the report data 84 to a file according to various export formats 176 including, but not limited to, a CSV format, a TSV format, and an XML format. The file can then be configured to be sent to a particular printer, to be included in the notification data 82, or to be stored in the client information datastore 118 via export configuration data 174.

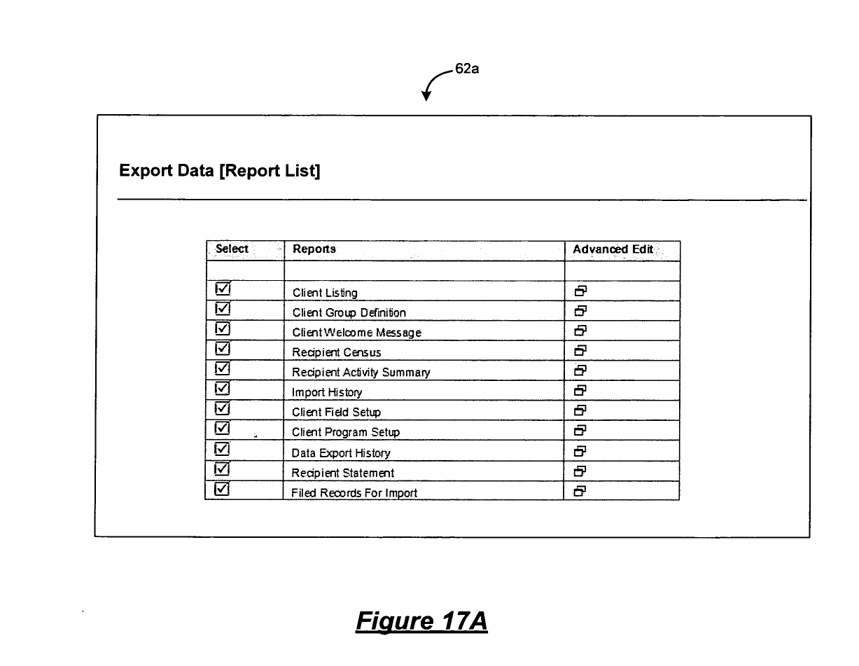

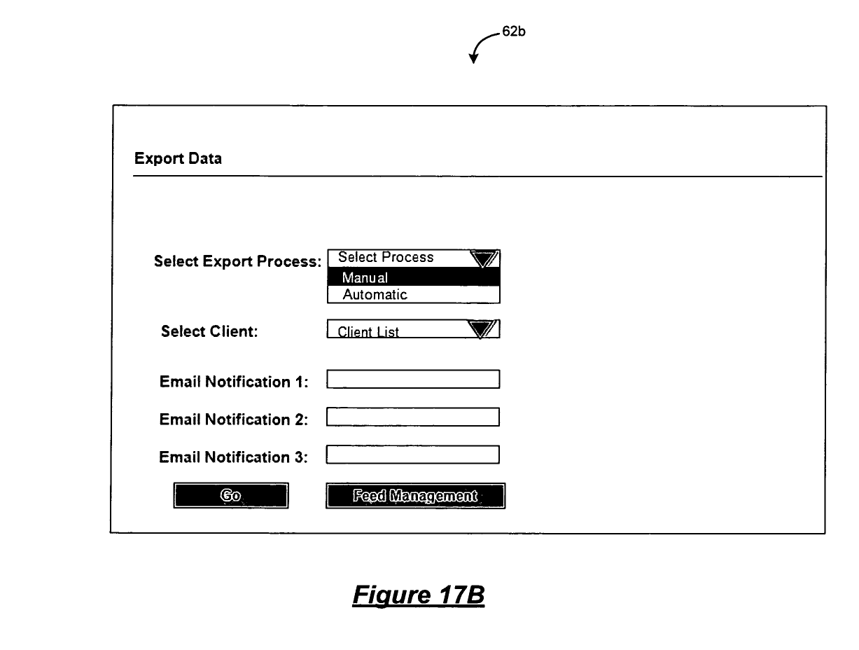

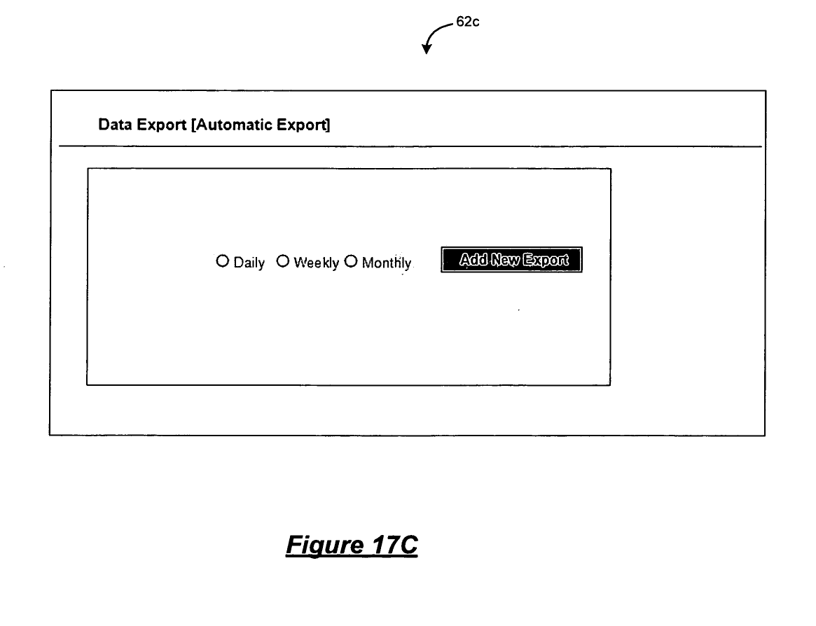

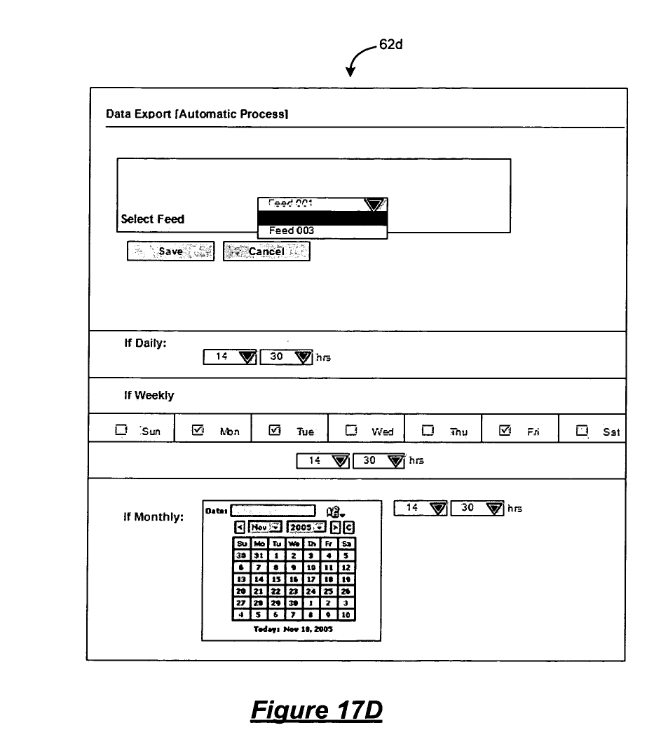

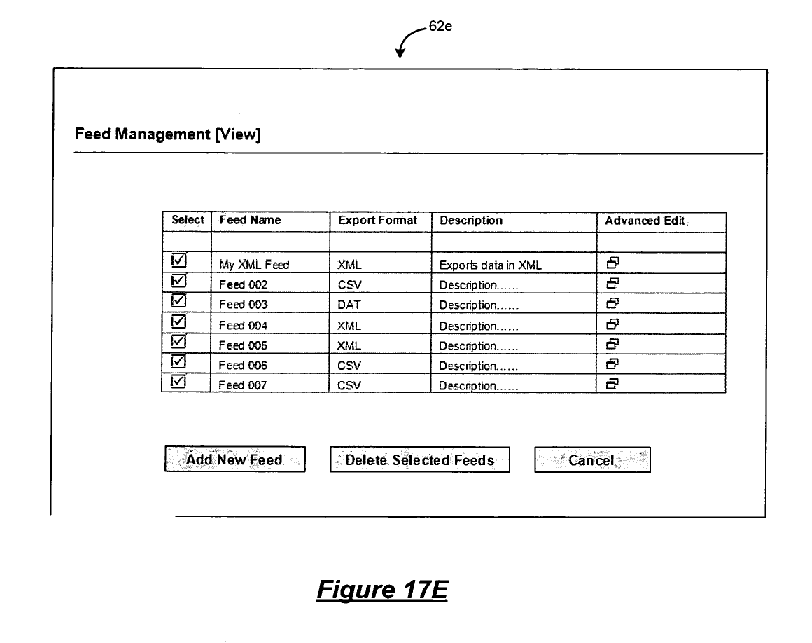

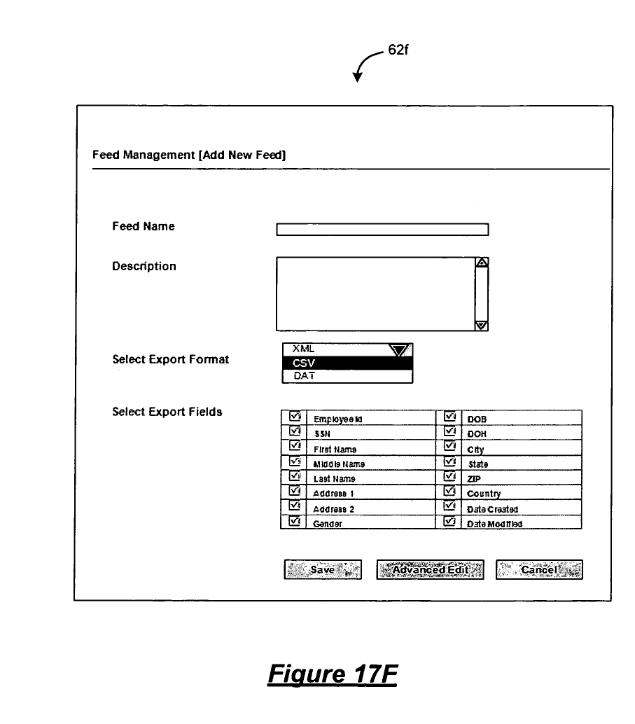

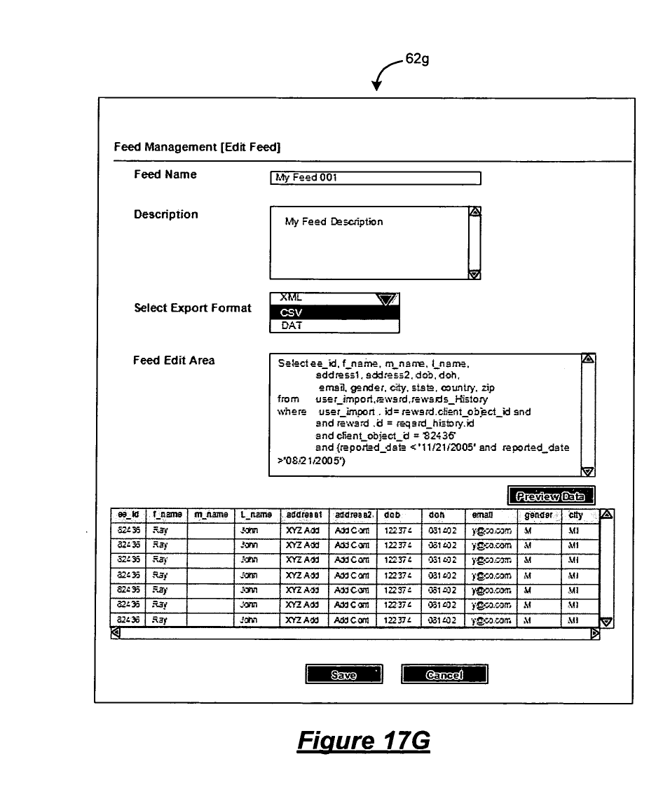

The data export sub-module 170 generates data export interface data 182 for use by the interface management module 42 (FIG. 2) to generate one or more data export interfaces 62 (FIG. 2). Exemplary data export interfaces are shown in FIGS. 17A-17G. In particular, FIG. 17A illustrates a data export interface 62a used to select a predefined report type 178. FIG. 17B illustrates a data export interface 62b used to select the export type 172. FIGS. 17C-17G illustrate data export interfaces 62c-62g used to configure the export format 176 and export configuration data 174, including where to export the report data 84.

While specific aspects have been described in this specification and illustrated in the drawings, it will be understood by those skilled in the art that various changes can be made and equivalents can be substituted for elements thereof without departing from the scope of the present teachings, as defined in the claims. Furthermore, the mixing and matching of features, elements and/or functions between various aspects of the present teachings may be expressly contemplated herein so that one skilled in the art will appreciate from the present teachings that features, elements and/or functions of one aspect of the present teachings may be incorporated into another aspect, as appropriate, unless described otherwise above. Moreover, many modifications may be made to adapt a particular situation, configuration or material to the present teachings without departing from the essential scope thereof. Therefore, it is intended that the present teachings not be limited to the particular aspects illustrated by the drawings and described in the specification as the best mode presently contemplated for carrying out the present teachings but that the scope of the present teachings will include many aspects and examples following within the foregoing description and the appended claims.

What is claimed is:

1. A computer program product for managing health care educational information, comprising:
a course assignment module operable to assign health care educational courses to a plurality of health care recipients;
a reward management module operable to associate rewards with the heath care educational courses; and
a course administration module operable to administer the health care educational courses to the plurality of health care recipients and to award rewards to the health care recipients based on a performance of the health care educational courses.

2. The computer program product of claim 1 wherein the course assignment module automatically assigns the health care educational courses based on health information related to the plurality of health care recipients.

3. The computer program product of claim 2 wherein the health information includes health risk assessment data.

4. The computer program product of claim 2 wherein the health information includes health care carrier claims data.

5. The computer program product of claim 1 wherein the course assignment module manually assigns the health care educational courses based on user input received via a user interface.

6. The computer program product of claim 1 wherein the health care educational course includes an electronic test, wherein the reward management module is operable to associate a reward with a performance of the electronic test, and wherein the course administration module is operable to administer the electronic test and to award the rewards based on a performance of the electronic test.

7. The computer program product of claim 1 wherein the rewards can be at least one of monetary rewards, health related gift prizes, and employment incentives.

8. The computer program product of claim 7 wherein the reward is a monetary ward that is deposited to a health care spending account.

9. The computer program product of claim 1 further comprising a course builder module operable to create the health care educational courses based on information entered by a user.

10. The computer program product of claim 9 wherein the course builder module is further operable to at least one of create tests for the educational courses and assign tests for the educational courses.

11. A computer program product for managing health care educational information for a plurality of clients, comprising:
an import module operable to import health care data associated with a plurality of health care recipients employed by the plurality of the clients;
a course assignment module operable to automatically assign health care educational courses to the plurality of health care recipients based on the health care data; and
a course administration module operable to automatically administer the assigned health care educational courses to the plurality of health care recipients.

12. The computer program product of claim 11 further comprising a course builder module operable to create the health care educational courses based on user input entered via a user interface.

13. The computer program product of claim 12 wherein the course builder module at least one of creates electronic health care tests and associates electronic health care tests with the health care educational courses.

14. The computer program product of claim 13 further comprising a reward management module operable to individually or collectively configure rewards for the plurality health care recipients, and wherein the course administration module automatically awards the rewards to the plurality of health care recipients based on a performance of at least one of the health care educational course and the electronic health care test.

15. The computer program product of claim 14 further comprising a data export module operable to generate client reports indicating at least one of the performance of and the rewards earned by the plurality of health care recipients.

16. The computer program product of claim 11 wherein the import module is further operable to group health care recipients based on the health care data and wherein the course assignment module assigns the health care educational courses to the health care recipients based on their respective group.

17. The computer program product of claim 11 wherein the health care data includes health care carrier claims data and wherein the course assignment module automatically assigns health care educational courses to the plurality of health care recipients based on the health care carrier claims data.

18. The computer program product of claim 11 wherein the health care data includes health risk assessment data and wherein the course assignment module automatically assigns health care educational courses to the plurality of health care recipients based on the health risk assessment data.

19. A computer program product for enabling a computer to manage health care educational information for a plurality of clients, comprising:
software instructions for enabling the computer to perform predetermined operations; and
a computer readable medium bearing the software instructions, the predetermined operations including:
defining electronic health care educational courses based on user input;
importing health care data associated with a plurality of health care recipients employed by the plurality of clients; and
assigning electronic health care educational courses to the plurality of health care recipients based on at least one of user input and the health care data.

20. The computer program product of claim 19 wherein the predetermined operations further include automatically administering the electronic health care educational courses to the plurality of health care recipients.

21. The computer program product of claim 19 wherein the predetermined operations further include monitoring the health care recipients' performances of the health care educational courses.

22. The computer program product of claim 19 wherein the predetermined operations further include generating a notification to the plurality of health care recipients indicating the electronic health care educational courses assigned to that health care recipient.

23. The computer program product of claim 19 wherein the predetermined operations further include:
assigning electronic health care educational tests to the health care educational courses; and
administering the electronic health care educational tests.

24. The computer program product of claim 23 wherein the predetermined operations further include assigning rewards based on a performance of at least one of the electronic health care educational courses and the electronic health care educational tests.

25. The computer program product of claim 19 wherein the predetermined operation of importing further includes importing health care carrier claims data and wherein the assigning further includes automatically assigning the health care educational courses to the plurality of health care recipients based on the health care carrier claims data.

26. The computer program product of claim 19 wherein the predetermined operation of importing further includes importing health risk assessment data and wherein the assigning further includes automatically assigning the health care educational courses to the plurality of health care recipients based on the health risk assessment data.
